(19) United States
(12) Patent Application Publication
(10) Pub. No.: US 2026/0323613 A1
(43) Pub. Date: Oct. 15, 2026

(54) DISAGGREGATED USER EQUIPMENT (UE) ARCHITECTURE AND METHODS

(71) Applicant: Telefonaktiebolaget LM Ericsson (publ), Stockholm (SE)

(72) Inventors: Edgard FIALLOS, Solna (SE); Dániel GÉHBERGER, Montreal (CA); Klas JOHANSSON, Linkoping (SE); Johan EKER, Lund (SE)

(73) Assignee: Telefonaktiebolaget LM Ericsson (publ), Stockholm (SE)

(21) Appl. No.: 19/484,308

(22) PCT Filed: Feb. 15, 2024
(86) PCT No.: PCT/IB2024/051440

§ 371 Date: Nov. 13, 2025

Related U.S. Application Data
(60) Provisional application No. 63/471,445, filed on Jun. 6, 2023.

(51) Int. Cl. H04W 72/0453

(52) U.S. Cl. CPC H04W 72/0453

(57) ABSTRACT

Embodiments implement disaggregated user equipment (UEs). A method for a UE physical layer server to interact with one or more UE clients comprises: receiving a request from a UE client through a control endpoint to allocate resources for the UE client; allocating internal resources of the UE physical layer server to the UE client upon determining that the request is to be granted, the internal resources including a context for the UE client to communicate with a base station through the UE physical layer server; providing a handle to the UE client, the handle to be used to identify the UE client for interactions between the physical layer server and the UE client, the UE client performing operations in one or more layers above physical layer of a UE; and performing one or more message exchanges between the UE physical layer server and the UE client through a data endpoint.

### CROSS-REFERENCE TO RELATED APPLICATIONS

This application claims the benefit of U.S. Provisional Application No. 63/471,445, filed Jun. 6, 2023, which is hereby incorporated by reference.

### TECHNICAL FIELD

Embodiments of the invention relate to the field of networking; and more specifically, to the disaggregated user equipment (UE).

### BACKGROUND ART

A number of approaches have been proposed as solutions for UE simulation. A first earlier approach describes a scalable architecture for Long Term Evolution (LTE) multiple UE simulation using a combined digital signal processing (DSP) and Field Programmable Gate Array (FPGA) system. The described multi-UE simulator is connected to a single Evolved Node B (eNodeB). A common section of the signal processing is performed together for all UEs, this includes the processing up until Channel Estimation & Equalization. After this, a UE specific processing is done for each UE. The processed signal is then sent to a Radio Link Control and/or Medium Access Control layer (RLC/MAC layer) for higher layer processing. That approach also defines that signal processing may be done in sequential manner or in parallel.

A second earlier approach defines a method and system for uplink multiple input output (MIMO) air interface testing via a multi-UE simulator. The simulator receives uplink grants for transmission for multiple UEs and assigns overlapping (in time) grants to different uplink signal processing chains and associated different antennas. Similarly, a third earlier approach defines a method and system for simulating per UE signal fading to test air interface devices using per UE signal generation chains.

A related concept, Fifth Generation (5G) Functional Application Programming Interface (FAPI), is defined by the Small Cell Forum as a set of specifications defining a interface between the MAC (Medium Access Control) layer and the PHY (Physical) layer (MAC-PHY interface) specifically for the 5G Next Generation Node B (gNodeB). A 5G UE FAPI-like interface is defined in a standard entitled “5G-New Radio (NR) User Equipment (UE) API-like Interface,” EURECOM OpenAirInterface, dated August 2018. This interface specifies the interaction procedures and messages between a 5G UE MAC and PHY layer inside a single UE.

### SUMMARY OF THE INVENTION

Embodiments include methods, electronic devices, storage medium, and computer program for implementing disaggregated user equipment (UEs). In one embodiment, a method is disclosed for a UE physical layer server to interact with one or more UE clients. The method comprises: receiving a request from a UE client through a control endpoint of the UE physical layer server to allocate resources for the UE client; allocating internal resources of the UE physical layer server to the UE client upon determining that the request is to be granted, the internal resources including a context for the UE client corresponding to resources in the UE physical layer server for the UE client to communicate with a base station through the UE physical layer server; providing a handle to the UE client, the handle to be used to identify the UE client for interactions between the UE physical layer server and the UE client, the UE client performing operations in one or more layers above physical layer of a UE; and performing one or more message exchanges between the UE physical layer server and the UE client through a data endpoint of the UE physical server.

In one embodiment, an electronic device is disclosed to implement a user equipment (UE) physical layer server to interact with one or more UE clients. The electronic device comprises a processor and non-transitory machine-readable storage medium that provides instructions that, when executed by the processor, cause the electronic device to perform: receiving a request from a UE client through a control endpoint of the UE physical layer server to allocate resources for the UE client; allocating internal resources of the UE physical layer server to the UE client upon determining that the request is to be granted, the internal resources including a context for the UE client corresponding to resources in the UE physical layer server for the UE client to communicate with a base station through the UE physical layer server; providing a handle to the UE client, the handle to be used to identify the UE client for interactions between the UE physical layer server and the UE client, the UE client performing operations in one or more layers above physical layer of a UE; and performing one or more message exchanges between the UE physical layer server and the UE client through a data endpoint of the UE physical server.

In one embodiment, a non-transitory machine-readable storage medium is disclosed. The non-transitory machine-readable storage medium provides instructions that, when executed by a processor of an electronic device, cause the electronic device to perform: receiving a request from a UE client through a control endpoint of the UE physical layer server to allocate resources for the UE client; allocating internal resources of the UE physical layer server to the UE client upon determining that the request is to be granted, the internal resources including a context for the UE client corresponding to resources in the UE physical layer server for the UE client to communicate with a base station through the UE physical layer server; providing a handle to the UE client, the handle to be used to identify the UE client for interactions between the UE physical layer server and the UE client, the UE client performing operations in one or more layers above physical layer of a UE; and performing one or more message exchanges between the UE physical layer server and the UE client through a data endpoint of the UE physical server.

In one embodiment, a method is disclosed for a user equipment (UE) client to interact with a UE physical layer server. The method comprises: executing a service discovery to find a control endpoint of the UE physical layer server; sending a request to allocate resources for the UE client to the control endpoint of the UE physical layer server, the request indicating an identifier of the UE client; receiving a handle from the UE physical layer server; and performing interaction between the UE client and the physical layer server using the handle.

In one embodiment, an electronic device is disclosed to implement a user equipment (UE) client to interact with a UE physical layer server. The electronic device comprises a processor and non-transitory machine-readable storage medium that provides instructions that, when executed by the processor, cause the electronic device to perform: executing a service discovery to find a control endpoint of the UE physical layer server; sending a request to allocate resources for the UE client to the control endpoint of the UE physical layer server, the request indicating an identifier of the UE client; receiving a handle from the UE physical layer server; and performing interaction between the UE client and the UE physical layer server using the handle.

In one embodiment, a non-transitory machine-readable storage medium is disclosed. The non-transitory machine-readable storage medium provides instructions that, when executed by a processor of an electronic device, cause the electronic device to perform: executing a service discovery to find a control endpoint of the UE physical layer server; sending a request to allocate resources for the UE client to the control endpoint of the UE physical layer server, the request indicating an identifier of the UE client; receiving a handle from the UE physical layer server; and performing interaction between the UE client and the UE physical layer server using the handle.

These embodiments enable distributed deployments with one or more UE clients to interact with a single UE physical layer server and allow an efficient and scalable solution to emulate and/or testing of radio networks.

### BRIEF DESCRIPTION OF THE DRAWINGS

The invention may best be understood by referring to the following description and accompanying drawings that are used to illustrate embodiments of the invention. In the drawings:

FIG. 1 shows an operating environment of UEs interacting with RAN per some embodiments.

FIG. 2 shows the overall system architecture per some embodiments.

FIG. 3 shows the operations of a UE physical layer server (PHY server) to process UE allocation and deallocation requests per some embodiments.

FIG. 4 shows startup operations of a UE MAC client per some embodiments.

FIG. 5 shows the normal operation of a UE MAC client per some embodiments.

FIG. 6 shows the termination operation of a UE MAC client termination per some embodiments.

FIG. 7 shows the deployment of an inline UE PHY (L1) server in the context of a digital twin test environment per some embodiments.

FIG. 8 shows a realization of a synchronized system clock used to coordinate communication per some embodiments.

FIG. 9 illustrates a few basic use cases in some embodiments, where L2 to L1 communication for sending memory access pattern per some embodiments.

FIG. 10 describes the high-level behavior of the L1 server per some embodiments.

FIG. 11 shows a procedure describing service-level (as opposed to UE-level) configuration per some embodiments.

FIG. 12 shows steps in UE L1 procedures per some embodiments.

FIGS. 13A-B illustrate the two exemplary types per some embodiments.

FIG. 14 shows UE L1 allocation procedure per some embodiments.

FIG. 15 shows a UE L1 deallocation procedure per some embodiments.

FIG. 16 shows a UE cell search procedure per some embodiments.

FIG. 17 depicts the expected sequence in the context of a successful execution path per some embodiments.

FIG. 18 shows the expected sequence in the context of a successful execution path per some embodiments.

FIG. 19 depicts the expected sequence in the context of a successful execution path per some embodiments.

FIG. 20 shows operations at a user equipment (UE) physical layer server (e.g., the UE PHY server or L1 server) per some embodiments.

FIG. 21 shows operations at a user equipment (UE) client (e.g., a UE MAC client and/or UE L2) per some embodiments.

FIG. 22A shows an exemplary signal transmission hierarchy in a wireless network.

FIG. 22B shows resource elements used for data and signaling transmission.

FIG. 23 illustrates an electronic device implementing UE L1/L2 interaction coordinator per some embodiments.

FIG. 24 illustrates an example of a communication system per some embodiments.

FIG. 25 illustrates a User Equipment (UE) per some embodiments.

FIG. 26 illustrates a network node per some embodiments.

FIG. 27 is a block diagram of a host, which may be an embodiment of the host of FIG. 24, per various aspects described herein.

FIG. 28 is a block diagram illustrating a virtualization environment in which functions implemented by some embodiments may be virtualized.

FIG. 29 illustrates a communication diagram of a host communicating via a network node with a UE over a partially wireless connection per some embodiments.

### DETAILED DESCRIPTION

The first to third earlier approaches discussed herein above have their challenges in simulating operations of a realistic radio network deployment. For example, they fail to provide unique channel conditions for the simulated individual user equipment (UEs) (referred to as simulated UEs, softUEs, or soft UEs) in a computationally efficient manner. State of the art solutions roughly fall into two categories. Solutions in the first category provide non-unique channel conditions for each UE, for example by simply providing an identical setup for all UEs. These simulations thus fail to correctly capture changes in the radio channel due to factors such as fading. Alternatively, in the second category, the simulation naively emulates one Physical Layer (L1 layer or PHY layer) per UE, which becomes prohibitively computationally expensive.

Furthermore, existing solutions operate in relation to a single base station that limits the testing of some deployment scenarios (e.g., handovers or cell search). Also, there is no published softUE architecture that would allow distribution with a pooled L1 processing and separate higher layer instance.

The core limitation of the first earlier approach is that it defines a single hardware system containing all the L1 (PHY) and L2 (RLC/MAC) and higher processing components. This limits the scalability and makes the system not distributable. It defines a single RLC/MAC entity connecting to a single PHY entity. It is also specifically defined that a single eNodeB is used for the connection of all UEs over a wired connection or radio link, meaning that all UEs will experience the same physical channel conditions. Note that the terms of Layer 1 (L1) and physical layer (PHY) are used interchangeably herein, so are the terms of Layer 2 (L2) and RLC/MAC layer (RLC/MAC).

The systems and methods defined in the second and third earlier approaches use per UE dedicated signal processing chains to communicate with a single base station. Similarly, as before the “single box” design results in a limitation on scalability in these cases. Also, all UEs are connected to single base station/cell and as a result e.g., handover scenarios cannot be simulated.

The procedures and messages of the FAPI only cover the base station side interaction between the MAC and PHY layers and only in a one-to-one setting. The interface defined in the FAPI-like interface standard targets a single UE and defines a single MAC layer interacting with one or more PHY layers to support carrier aggregation. It also completely offloads the cell synchronization to the PHY layer and as such cannot support multi gNodeB/cell configurations or handovers.

### UE Distributed Deployment

This disclosure provides embodiments to overcome these and other challenges in earlier approaches. A novel architecture is proposed to enable distributed deployments with a defined MAC-PHY interface enabling connecting one or more MAC instances to a pooled single PHY instance. The embodiments provide careful design of an API and location of radio functionality to support the disaggregation of L1 and L2. This in turn will provide for an efficient and scalable emulation setup to, among other things, be used for testing radio networks.

As noted in the background the described disclosure is related to UEs providing dual (multi) active simulation (SIM) support where each simulation entity has a dedicated set of antennas. The described solution can be used to implement such a physical UE deployed in an operational radio network (referred to as a hard/real/physical UE) or softUE.

For (physical or simulated) handsets, the UE stack (L1, L2, L3) is typically very tightly integrated. This disclosure proposes a disaggregation of the stack by providing an efficient MAC-PHY separation. In a test or emulation scenario, this allows the L1 processing for all UEs to be aggregated or pooled, which accomplishes efficient and scalable acceleration. In relation to this, a well-defined UE MAC-PHY interface is required that includes an Application Programming Interface (API) description, message structures, service procedures (e.g., discovery) and UE specific procedures (e.g., management of uplink and downlink channels).

In addition to the architecture and the interface, some related aspects are also considered to be important:
Decoupling of the PHY and MAC layers by using independent (synchronized) time sources for the 3rd Generation Partnership Project (3GPP) timing events.
Automatically releasing buffers on the MAC-PHY interface based on 3GPP time passed since allocation.

Certain embodiments may provide one or more of the following technical advantages, including the following.
A clear interface allows for components to be more easily replaced and possibly provided by multiple actors. Today, no such interface exists.
The proposed design of a MAC-PHY interface enables efficient emulation and testing environments by using a PHY (L1) server handling multiple UEs simultaneously.
While the interface was primarily designed for the testing use case, the existence of an established interface will also provide opportunities for non-soft UEs. We envision future use cases involving physical handsets (or other communication devices) where the MAC and PHY interface would be beneficial.

This disclosure presents a proposal for a disaggregated stack for UEs and defines a novel media access control layer to physical layer interface (MAC-PHY interface). The use cases include digital testing of telecom networks where multiple UEs connect to a radio network. The digital test may use softUEs rather than physical handsets (also referred to as hard/real/physical UEs). For instance, when building a test environment like a “digital twin” for a RAN system, it is required to replicate the functions of several UEs running on Commercial-Off-The-Shelf (COTS) hardware. The digital twin of the RAN system is a virtual representation of the physical RAN infrastructure and its components. It is a digital replica that simulates the behavior and characteristics of the actual RAN system in real-time. While digital testing is used as an example of the novel MAC-PHY interface, the novel MAC-PHY interface may be used in a physical RAN system, where the MAC-PHY interface is used for the interaction between the MAC layer (L2 layer) of multiple UEs over a common PHY layer (L1 layer). For example, Dual (or multiple) active physical UEs (instead of simulated UEs) have as many (set of) antennas as simulations and the internal implementation can be related to the described solution.

Due to the computational requirements of L1 functions on the UE side, one or more accelerators (e.g., graphics processing units (GPUs)) may be used for efficient processing. The naïve approach with an accelerated L1 layer instance per UE does not scale well, while a single L1 instance processing the pooled set of UEs provides good scalability.

Some of the embodiments contemplated herein will now be described more fully with reference to the accompanying drawings. Embodiments are provided by way of example to convey the scope of the subject matter to those skilled in the art.

Systems with Novel MAC-PHY Interface

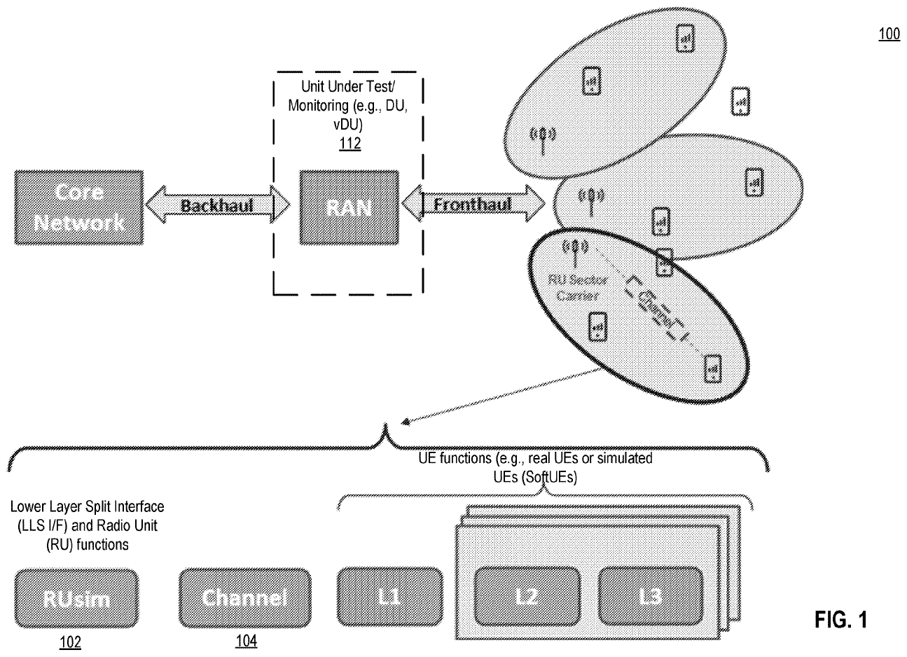

FIG. 1 shows an operating environment of UEs interacting with RAN per some embodiments. As FIG. 1 suggests, the radio access network (RAN) is the unit under test/monitoring at reference 112 in some embodiments. The RAN is the intermediary between UEs and core network. The UEs communicate with the RAN through fronthaul while the RAN communicates with the core network through backhaul.

In some embodiments, Radio Unit (RU) functions are realized by the RUSim module 102 and there is also a Channel or Channel Emulator 104 in between the RU and the UE L1 that gives time-variant channel conditions for each UE according to their location in (virtual) space.

The operating environment 100 may be used for simulation as well as testing in a real deployment. In simulation, the test environment may operate as a ‘Digital Twin’ for the corresponding RAN system, where the functions of several UEs are replicated running on COTS hardware. Due to the processing need of L1 functions on the UE side, accelerators (e.g., GPUs) should be used to process the pooled set of UEs for efficiency reasons. Radio Unit (RU) functions are realized by the RUSim module and there is also a Channel Emulator in between the RU and the UE L1 that emulates unique time-variant channel conditions for each UE according to their location in (virtual) space.

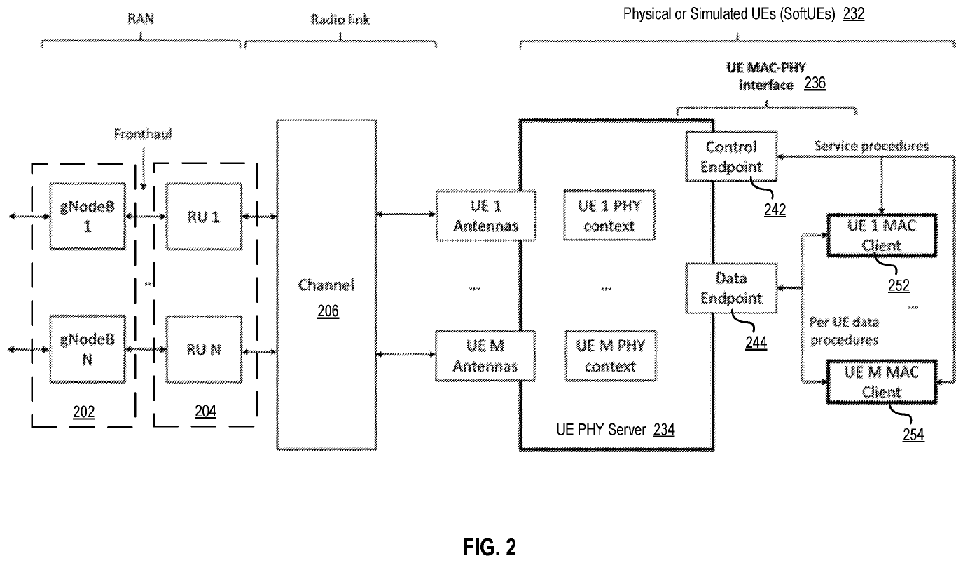

FIG. 2 shows the overall system architecture per some embodiments. The figure shows that on the RAN side one or more base stations such as gNodeBs 202 are present and connected to Radio Units (Rus) 204. Note that the figure is slightly simplified because a gNodeB might be connected to multiple Rus as well. The core takeaway of the RAN side of the figure is the one or more cells are present in the system. Channel 206 may be a virtual channel simulated with a channel emulator or radio channel implemented through radio signals. Note that while we use 5G terms and components in this description (e.g., gNodeB), the presented concept can be applied for different past and future generations of 3GPP or other radio/wireless systems (e.g., gNodeB is only one type of base stations that embodiments of the disclosure may be implemented).

The UE side includes physical or simulated UEs (softUEs) 232. A single UE Physical Layer (PHY) Server 234 processes the L1 of multiple softUEs and one or more softUEs present in the system. A softUE consists of a UE MAC Client (e.g., one of UE MAC client 252 or 254) that contains the MAC and higher layers of the UE stack and a UE PHY context with associated antennas or antenna ports (one or more depending on the MIMO configuration) inside UE PHY Server 234. The UE PHY Server 234 and the UE MAC Clients communicate over the described MAC-PHY interface.

The UE PHY Server exposes two endpoints:
Control Endpoint 242 is used for service procedures, including status requests, initial connection creation, UE handle allocation, and deallocation. The control endpoint is also used for service discovery, e.g., the UEs can find the Control Endpoint (e.g., IP address and port) at a well-known location.
The Data Endpoint 244 is used for uplink and downlink per UE data procedures. This endpoint might be realized using regular networking, or for example via shared memory communication for better performance.

The UE MAC-PHY interface 236 might be realized with a shared library used in the UE instances. This shared library provides an application programming interface (API) for the UEs to use that exposes the features of the UE PHY Server.

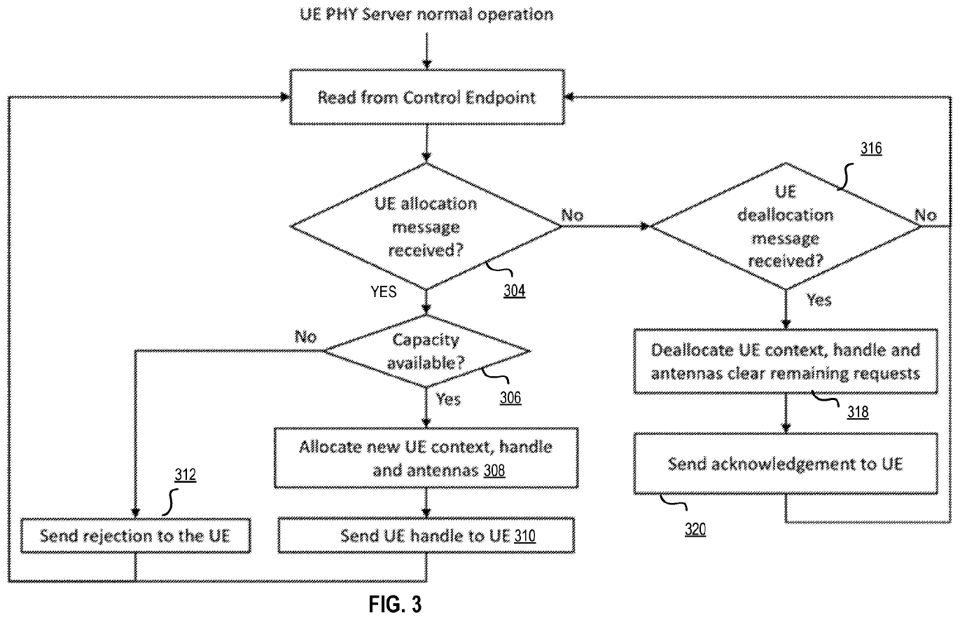

The UE PHY Server creates the Control Endpoint 242 at startup and might make connection details available for UE MAC Clients available at a well-known place (e.g., in a service registry). FIG. 3 shows the operations of a UE physical layer server (PHY server) to process UE allocation and deallocation requests per some embodiments. Note that there might be more request types handled via the Control Endpoint, e.g., status requests.

A UE MAC Client (shown in FIG. 2) provides, e.g., number of antennas, frequency band, bandwidth as part of the allocation request. The figure shows that once an allocation message is received from a UE MAC Client as determined at reference 304, it is validated if the UE PHY Server has the capacity to serve the Client at reference 306. If not, the flow goes to 312, where the allocation request is rejected. If the Client can be served, the UE PHY Server allocates internal resources such as a context, a handle, and one or more antennas at reference 308. The handle is during future interactions between the UE PHY Server and the UE MAC Client for identification. The handle is sent to the UE MAC Client at reference 310. The internal structure of the handle object is not meant to be parsed/understood on the UE MAC Client side. The handle might be created based on information received as part of the UE allocation (e.g., the information may include International Mobile Subscriber Identity (IMSI)). In case of the received message is not an allocation message but a UE deallocation message as determined at reference 316, the UE related resources are freed up through deallocating UE context, handle, and antennas, and clearing remaining requests at reference 318, and an acknowledgement is sent to the UE MAC Client at reference 320.

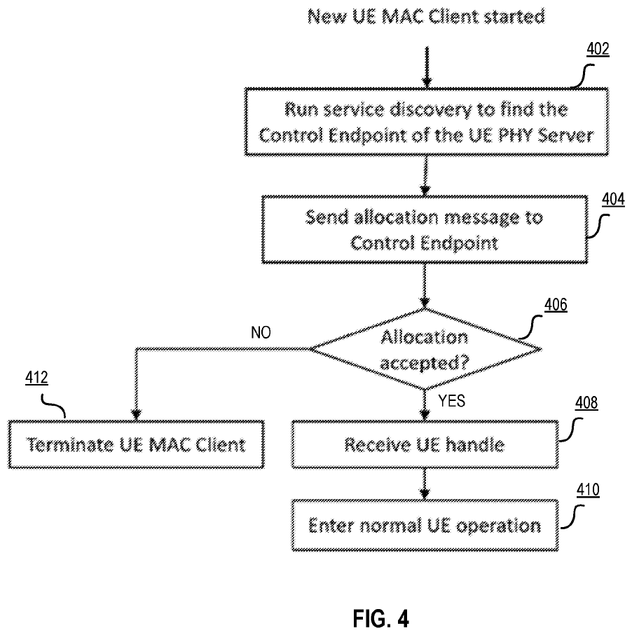

FIG. 4 shows startup operations of a UE MAC client per some embodiments. First, a service discovery is executed to find the Control Endpoint of the UE PHY Server at reference 402. This might be a query to a service registry or might be based on configuration input. The UE MAC Client then sends an allocation request to the UE PHY Server at reference 404. If the request is accepted as determined at reference 406, the UE handle is received at reference 408, and the UE enters normal operation at reference 410. Otherwise, the request is rejected, and the UE MAC client is rejected at reference 412. The UE MAC Client might also receive configuration related to the Data Endpoint that is to be used during normal UE operation.

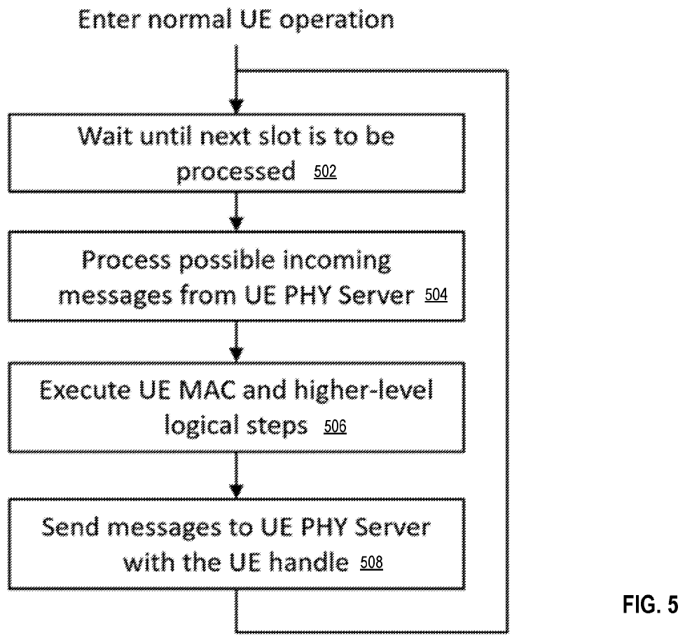

FIG. 5 shows the normal operation of a UE MAC client per some embodiments. The processing on the MAC Layer is slot based (see the Section of “Simulation Features” below for a related description). The process waits for the next slot to process an incoming message at reference 502. Once a message is received from a corresponding UE PHY server, the UE MAC client processes the message at reference 504. Messages are processed from the UE PHY Server's Data Endpoint and based on the messages and other configurations, the MAC and higher layer logic is executed at reference 506. Finally, any messages to be sent to the UE PHY Server are sent to the Data Endpoint with the UE handle included at reference 508.

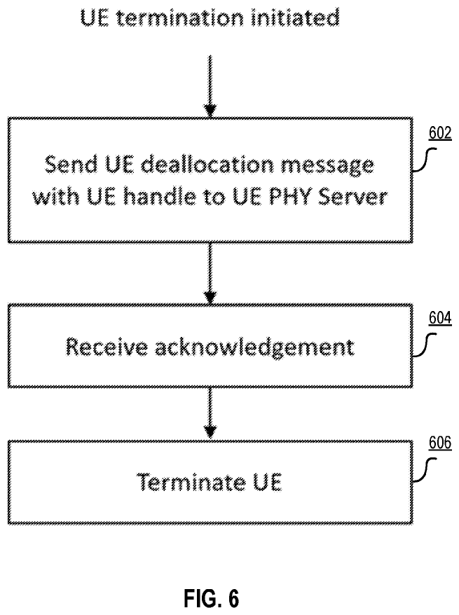

FIG. 6 shows the termination operation of a UE MAC client termination per some embodiments. Once the UE termination is initiated, the UE MAC client sends a UE deallocation message with UE handle to a corresponding UE PHY Server at reference 602. Once an acknowledgement is received at reference 604, the UE MAC client terminates the UE at reference 606.

### Simulation Test

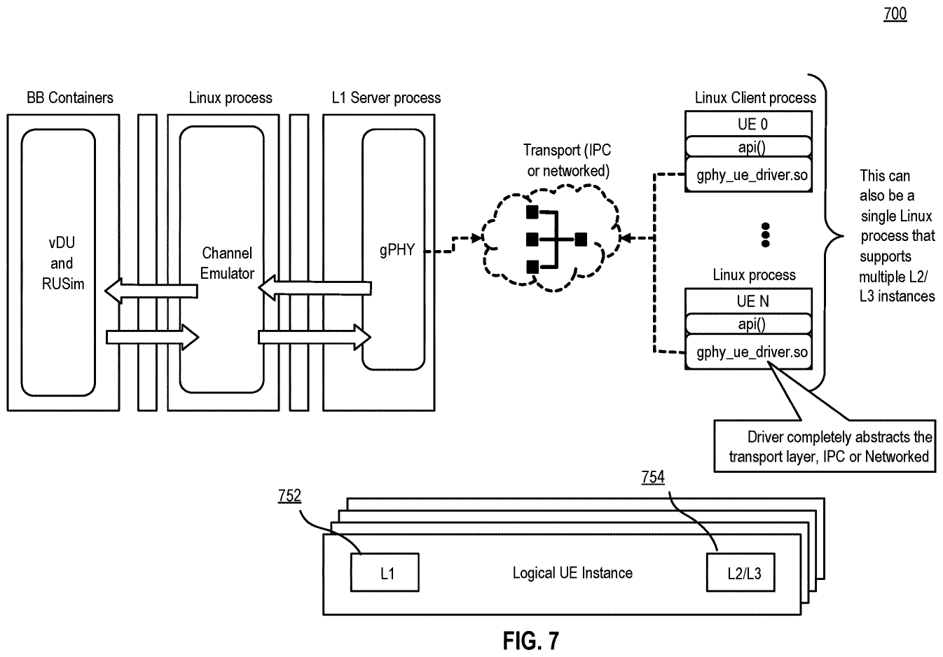

While the operations shown in FIGS. 1 to 6 may be used in both real RAN deployment and simulation test, further details are discussed regarding simulation test. FIG. 7 shows the deployment of an inline UE PHY (L1) server in the context of a digital twin test environment per some embodiments. The UE PHY L1 server may be implemented using one or more accelerators in some embodiments. System 700 includes a disaggregated UE stack deployment in a virtual distributed unit (vDU) digital test context.

In some embodiments, the L1 server 752 and L2/L3 instances 754 correspond to the UE physical layer server (e.g., UE PHY server 234) and UE MAC client (e.g., one of UE MAC client 252 or 254), respectively. From this diagram, the following points are to be noted per some embodiments:
The L1 server is an independent process that can support the creation of multiple L1 contexts. These contexts completely abstract the connection to the Channel Emulator based on a given configuration, e.g., number of antennas, bandwidth, etc. towards the higher layers.
The L2/L3 instances can be in different processes or hosted in a single process that can support multiple UE instances. The addressability method is based on an L1 local identifier which can be used as a handle for each instance. This identifier may be expressed as an integer value {0 . . . N}.
The L2/L3 instances can communicate with the L1 server via a shared object library (ue_driver.so), which acts as a software driver that encapsulates the transport layer and other implementation aspects of the channel emulator, as well as the overall connection to the vDU.

The UE L1 server is deployed as a stand-alone process that supports a message-based interface. The networking details (e.g., transport method and serialization) are implemented by the shared object library (ue_driver.so). This software module acts as a driver which can be dynamically linked to any client L2/L3 UE process requiring acceleration of L1 functions.

### Simulation Features

In this section we provide simulation features that are implemented in some embodiments.

### NR Time Based Slot Indication in UE MAC

UE MAC and higher layer operations are governed by 3GPP timing as certain messages need to be sent and received in accordance with a given moment in time. A given moment in time is identified with a System Frame Number, Subframe, Slot and Symbol. Typically, the MAC layer derives timing from the PHY layer by receiving Slot indications (e.g., in case of the gNodeB side, the FAPI specification cited above describes slot indications in details). The length of each slot and as a result the frequency of indications depends on the used numerology.

In the described multi-UE environment, sending such indications to each UE results in a high volume of messages competing with the regular uplink and downlink related interaction between the layers. Furthermore, it needs to be ensured that messages arrive with extremely low jitter that poses further complication if one or more networking hops are also included.

In the proposed solution, a synchronized system clock is used to coordinate communication instead of explicit slot indications. 3GPP over the air communication is aligned to GPS clock. Regular system time then can be converted to what we call NR Time, a number of radio slots elapsed since a well-known point in time, e.g., midnight of 1980 Jan. 1.

In single physical node deployments (i.e., physical layer server and UE instances are deployed to the same node) there is no specific synchronization needed as all components can query the single system time and convert it to NR Time. For multi node cases it is possible to equip each node with a GPS receiver or use protocols such as PTP (Precision Time Protocol) to synchronize the clocks of nodes similarly to the radio access network side.

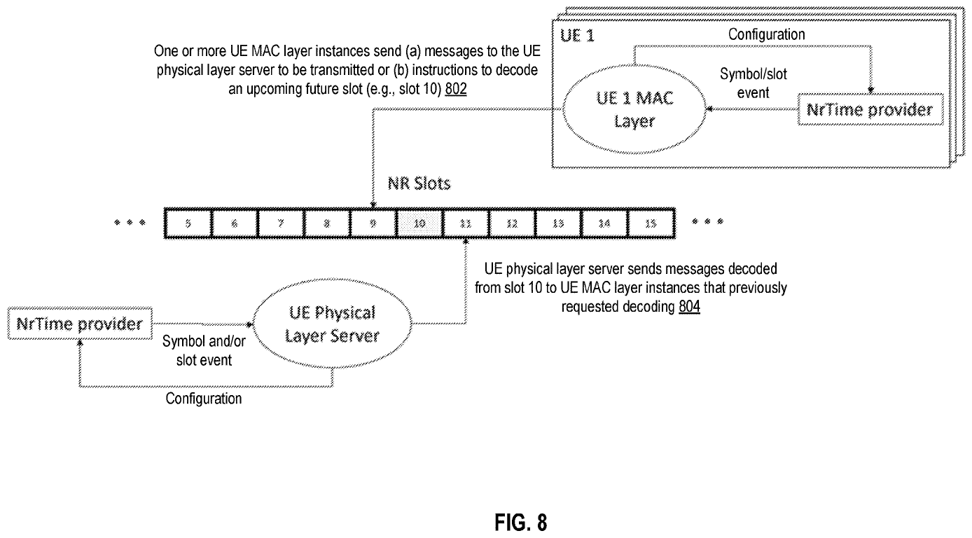

FIG. 8 shows a realization of a synchronized system clock used to coordinate communication per some embodiments. In the figure, the UE Physical Layer Server and each UE instance are connected to an NrTime Provider that can generate slot or symbol events based on system time. The NrTime Provider is first configured e.g., for the current numerology that determines how system time is converted to NR Time and essentially the event rate. We note that in case the UE Physical Layer Server is serving multiple numerologies it might request events for the highest numerology or for each numerology.

In the given example when the NrTime Provider in the UE instances generate event for slot 9 in the given radio frame, one or more UEs send messages (e.g., downlink decoding request or uplink transmission request) over the described MAC-PHY interface for an upcoming future slot (e.g., slot 10) at reference 802. On the other side, the UE Physical Layer server processes uplink and downlink related requests using its own events from the NR Time provider and sends messages to the UEs over the described MAC-PHY interface at reference 804.

### Time Limited Buffers Between the PHY and MAC Layers

During both uplink and downlink communication procedures buffers are used to communicate between the UE PHY Server and the UE MAC Clients. Buffers contain messages between the layers that might carry different information, e.g.:
For Physical Downlink Control Channel (PDCCH)
   request from MAC to PHY to decode Downlink Control Information (DCI) at a specific time and frequency location
   response from PHY to MAC with the DCI
For Physical Downlink Shared Channel (PDSCH)
   request from MAC to PHY to decode incoming data according to a specific configuration (e.g., MCS, # of PRBs, etc.).
   response from PHY to MAC with the actual decoded data.
For PUSCH data to be transmitted along with a time and frequency location.

In case of a shared memory-based implementation on the interface between the UE PHY Server and the UE MAC Clients, buffer ownership is a critical question. Specifically, where buffers are allocated and freed. In traditional implementations when a buffer is exposed from one entity to the other, a second round of interaction is required to signal that the buffer has been processed and can be freed.

Some embodiments may use an automatic buffer release mechanism based on a pre-defined time, expressed in radio slots. Messages in both directions (MAC to PHY and PHY to MAC) are time sensitive and valid for a limited time therefore it is safe to assume that it can be discarded after a time period.

As an example, on the downlink (PHY to MAC), a buffer would be allocated either for DCI or transport blocks and filled in by the PHY Server and handed over to the MAC Client. The buffers are then released and become invalid a specific number of NR slots later (e.g., one radio frame later). The release time or lifetime of the buffer might be communicated as part of the message. The release time might be given as a configuration or tuned or adjusted automatically in a given environment based on e.g., monitoring of the components.

### MAC-PHY API

The shared library offers the following APIs to the UE MAC and higher layers to support the communication with the UE L1 Accelerator:
(1) int GPhyInit ( . . . );

This function allows for the definition of transport type such as:
Transport type: transmission control protocol/user datagram protocol (TCP/UDP), shared memory, etc.,
SLOT_IND per UE or none (i.e., use NR Time at the client side)
PDCCH config option
as well as other operating parameters.
(2) GphyMsg::allocate<T>(size);

The client can allocate memory using the GphyMsg::allocate<T> (size) function call where T is the message type and size is an optional extra size that will be added to the message size. For example, to create a message for PUSCH allocation, the following recipe can be followed:
auto*msg=GphyMsg::allocate<GPhyIfPuschAllocMsg>(1234); //where the transport block size is 1234 bytes.

The L2 actor can then use this buffer to populate the content of the parameters required to send a PUSCH transmission. Note that L2 does not need to concern itself with freeing the memory since this buffer is managed by the interface library.

Note that the L2 actor will block on the message sending, not on the response from L1 server. In this context, blocking and non-blocking refer to a linux thread need to wait for the return from the function call to send the message.
(3) int GPhyUeMsgSend(GphyMsg*msg);

Using the message pointer from the previous API (*msg), this function can be used to instruct the interface library to transmit the message to the L1 Server or L1 Instances.

This is a blocking function used by the L2/L3 actor to specify the message to be sent to the L1 Accelerator.
(4) GphyMsg*GPhyUeMsgQuery( );

This non-blocking function is used to poll for a message from the L1 server. In this case the function returns a pointer to a buffer containing the message sent by the L1 server. The client doesn't need to care about freeing the memory.

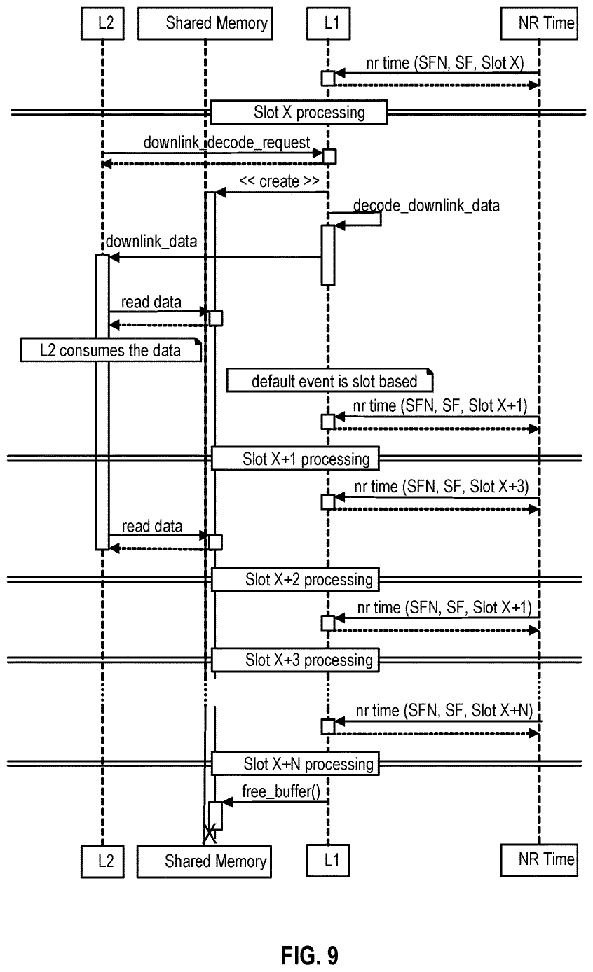

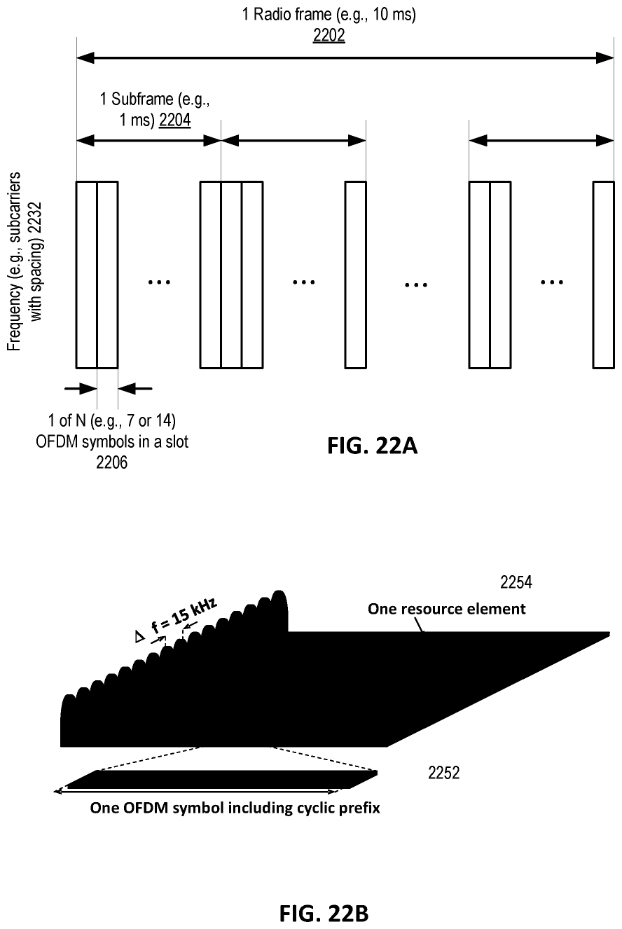

FIG. 9 illustrates a few basic use cases in some embodiments, where L2 to L1 communication for sending memory access pattern per some embodiments. Note that subframe (SF), subframe number (SFN), and slot numbers are passed from a NR time for synchronization. See more about slot, frame, and subframes in the discussion relating to FIG. 22A.
(5) GPhyIf3gppTime GphyGetNrTime(void*nrTime);

UE MAC and higher layer operations are governed by 3GPP timing as certain messages need to be sent and received in accordance with a given moment in time. A given moment in time is identified with a System Frame Number (SFN), Subframe (SF), Slot and Symbol (see FIGS. 9 and 22A). This helper function can aid the Client to validate incoming messages but also to schedule operation towards the L1 server. The definition of the GPhyIf3gppTime data structure is below per some embodiments:

```
typedef struct {
  uint16_t radioFrame;
  uint16_t subFrame;
  uint16_t slot;
  uint16_t symbol;
  uint64_t timeInNs;
} GPhyIf3gppTime;
```

This data type is found in every message as part of the standard header. It is included for the purpose of debugging and tracing of messages exchanged between L1 and L2. Much of the interactions between L1 and L2 are time sensitive and therefore their values are only valid during a very specific time window, hence time stamping message transmission and reception is absolutely critical to determine communication latencies or sub-system malfunction.

### L1 Service Procedures

Below is summary of the messages associated with L1 Server scope procedures:
STATUS_REQ
STATUS_RESP
CONFIG_REQ
CONFIG_RESP

The context of the above messages is best understood by describing the Finite State Machine (FSM) governing the L1 Server.

### L1 Server States

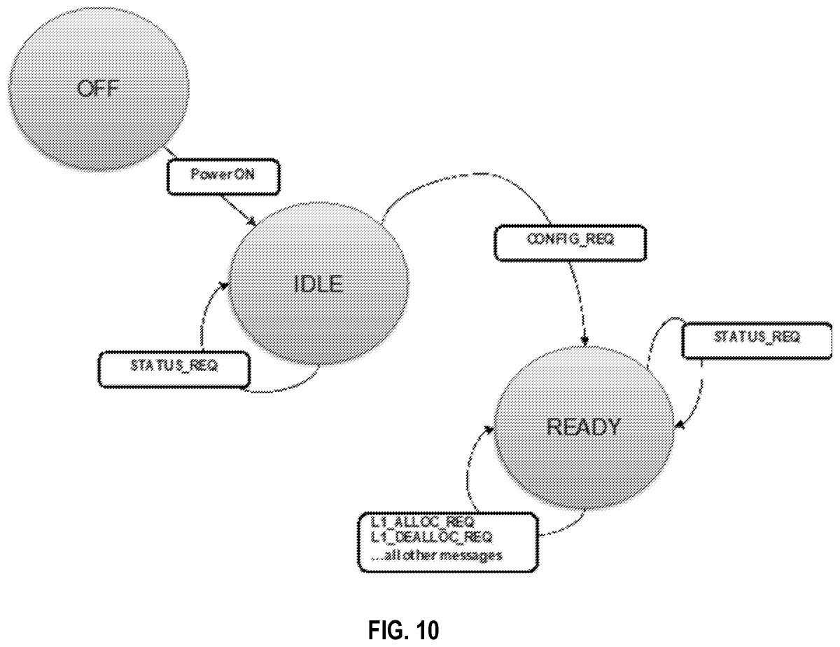

FIG. 10 describes the high-level behavior of the L1 server per some embodiments.

### Off

This state indicates that the L1 server has not be found (or created). This is determined by the discovery process initiated by the driver to determine if the L1 Server process has been created in the system and that it has responded to an initial STATUS_REQ.

### Idle

This state indicates that the L1 server process exists but is not yet configured. During this state the L1 server can accept a CONFIG_REQ message. Note that only one L2/L3 Client can act as a configuration actor. Although the L1 Server can support connections to multiple L2/L3 Clients for L1 instance procedures (i.e., cell search, PUSCH transmissions, etc.), only one external entity can configure the global settings for the L1 Server.

In a simplified realization this state might be bypassed to allow for a fixed configuration that can be loaded e.g., from a configuration file at startup.

### Ready

This state indicates that the L1 server has received global configuration to determine general behavior.

This state indicates that the L1 server has been configured, and it has established communication with the vDU via the channel emulator. This has many implications, such as the fact that Radio Frame synchronization has been established.

Only after this state is reached, the L1 server will be able to accept UE specific procedures (see section of “L1 per-UE procedure” below).

### Status_REQ/RESP

This procedure allows the Client to determine several things:
Discovery
Protocol version
Statistics
Etc.

### Conf_REQ/RES

FIG. 11 shows a procedure describing service-level (as opposed to UE-level) configuration per some embodiments.

### L1 Per-UE Procedures

Below is summary of the messages associated with associated with per-L1 scope procedures:
UE_ALLOC_REQ
UE_ALLOC_RESP
UE_DEALLOC_REQ
UE_DEALLOC_RESP
SLOT_IND

Detailed description of the above messages is found in the following sections.

The prerequisite for these procedures is that the UE L1 server is READY. In the READY state, the procedures shall be executed like this:

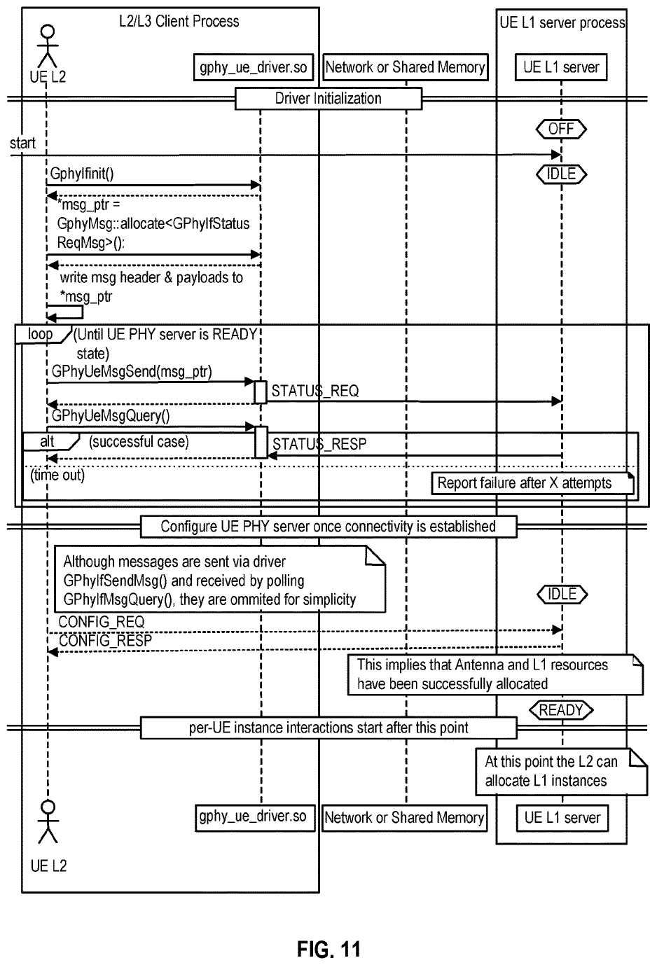

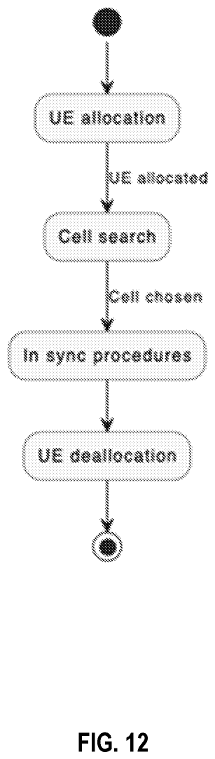

FIG. 12 shows steps in UE L1 procedures per some embodiments.

The UE L1 server supports one or more clients, and each client may run one or more UEs. This supports two principal types of deployments of the higher layers:
A single deployment unit (for example a container/pod) which runs multiple UEs.
Multiple deployment units (for example containers/pods) which run one UE each.

Messages from different clients and for different UEs may be interleaved when interfacing the UE L1 server, in order to properly support concurrent and independent operation of the UEs.

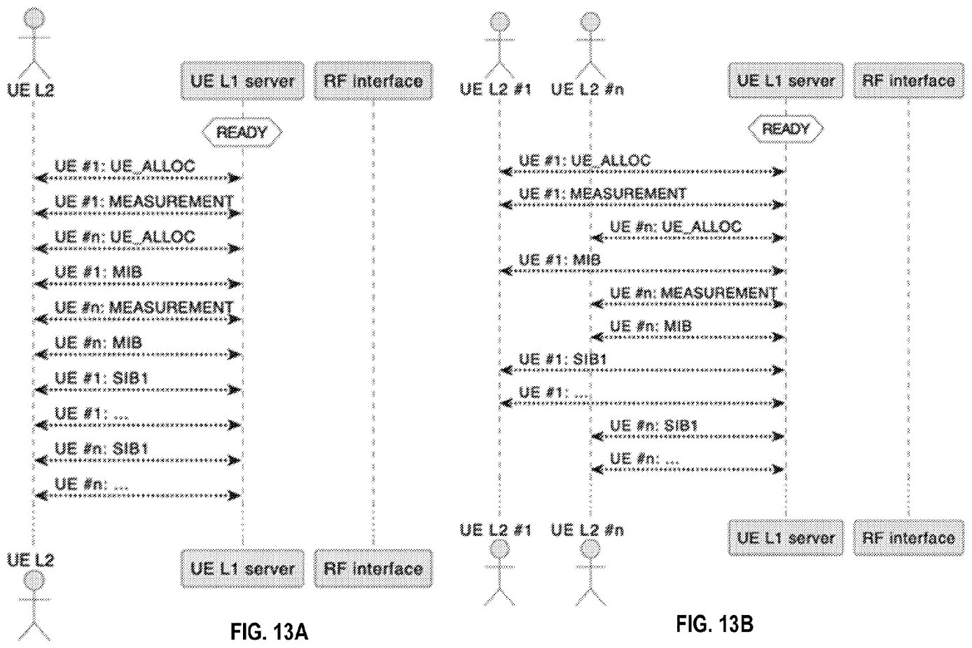

FIGS. 13A-B illustrate the two exemplary types per some embodiments. Note that these are not the only possible deployments.

### Device Configuration

This section describes procedures for configuring the UE “device.” In a handset, there are aspects that are wired into the hardware-like the number and configuration of antennas.

### UE_ALLOC_REQ/RESP

This procedure is used to allocate physical resources associated with a given UE L1 context. The L1 server has a finite number of physical resources, i.e., antenna buffers, processing capacity, etc. When the client requests a new UE L1 resource, it receives a handle in the form of a simple integer value in some embodiment (provided the maximum value has not been exceeded).

Once this unique identifier is received, the client shall use it in any subsequent per-UE specific procedures (e.g., transmit PUSCH data, etc.).

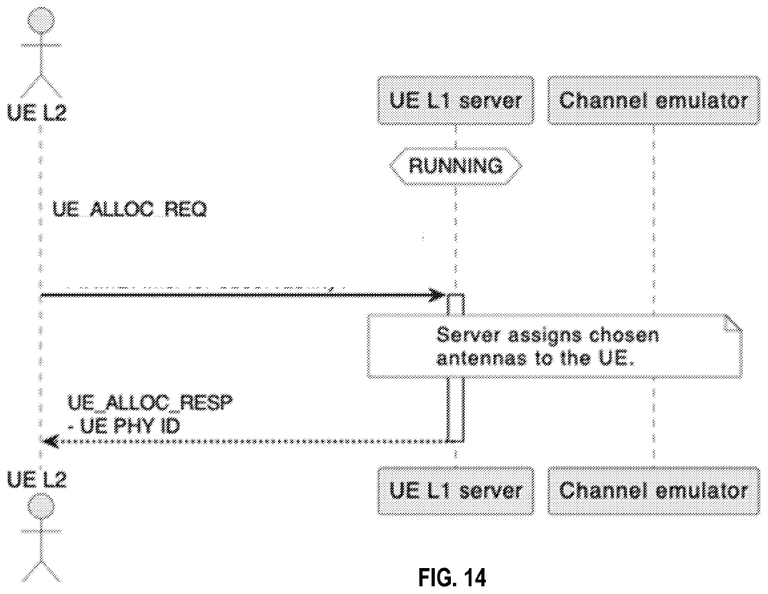

FIG. 14 shows UE L1 allocation procedure per some embodiments.

### UE_DEALLOC_REQ/RESP

This procedure is used to release the resources previously taken by UE_ALLOC_REQ.

The client is expected to explicitly order the deallocation, for example when powering off the UE. Note that the library and service may have measures in place to clean up dangling resources in the case of, for example, a crashing client, but this is only to be used for abnormal use cases.

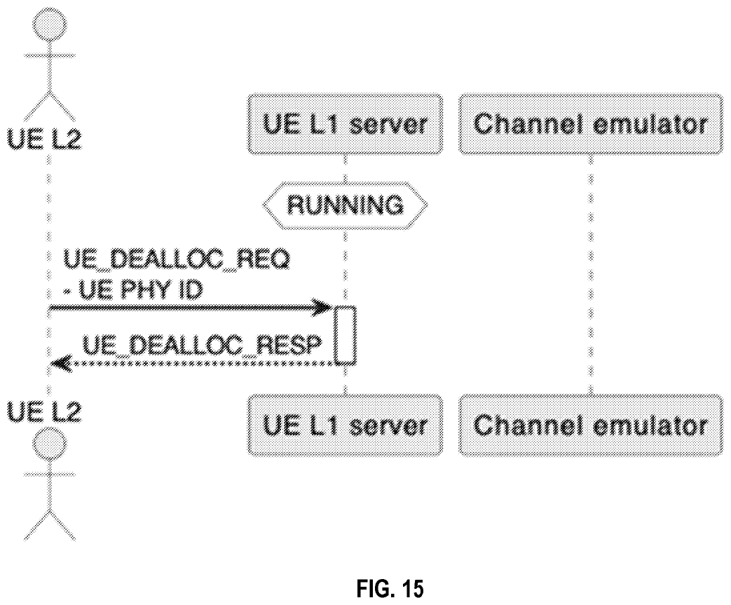

FIG. 15 shows a UE L1 deallocation procedure per some embodiments.

Applicable response codes are:

### Cell Search/Measurements

### Pre-Conditions.

UE executed the UE_ALLOC_REQ/RESP successfully.

### Design Assumptions

UE L1 performs the measurements as instructed by UE higher layers.
UE higher layers will use the measurements to choose the strongest cell and request UE L1 to acquire (through the relevant UE L1 procedures):
   PBCH/MIB (for use by UE higher layers to e.g., check if the cell is barred)
   PDSCH/SIB1 (for use by UE higher layers to e.g., check measurement thresholds and PLMN IDs)
The higher layers may need to perform the MIB/SIB1 acquisition for other cells if the strongest fails the selection criteria.

### Message Sequence

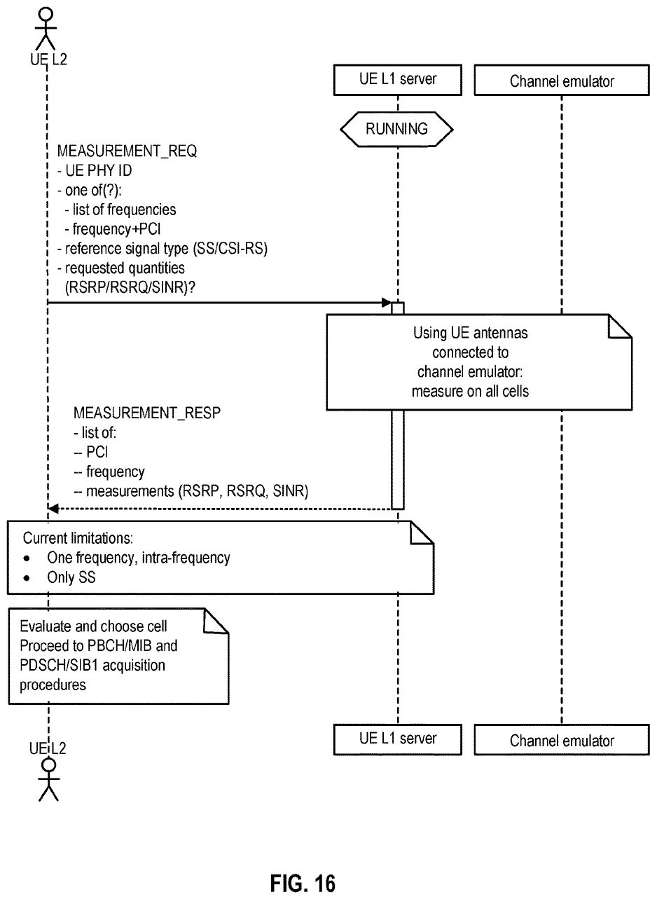

FIG. 16 shows a UE cell search procedure per some embodiments.

### PBCH/MIB Acquisition

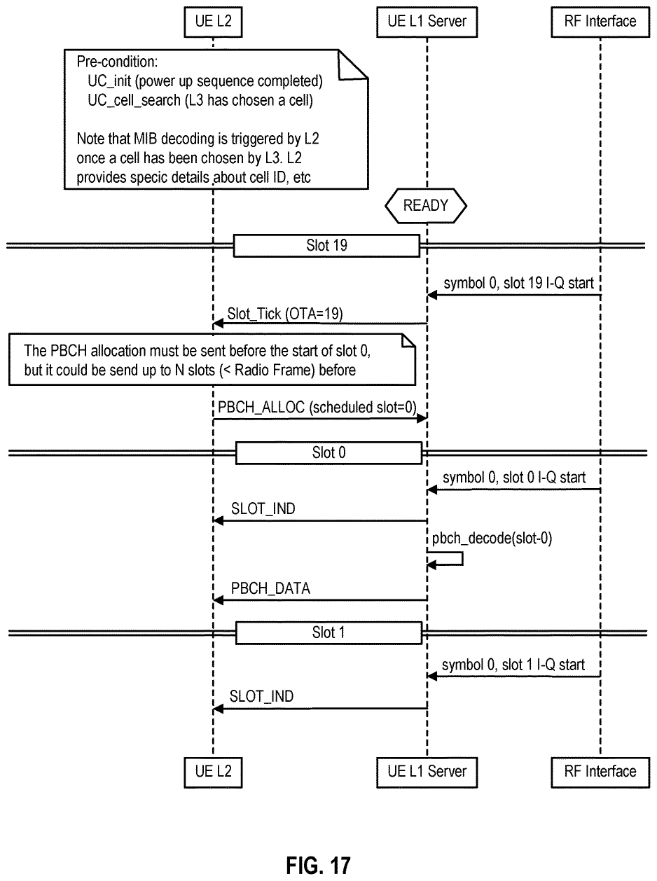

FIG. 17 depicts the expected sequence in the context of a successful execution path per some embodiments.

### SIB Acquisition (PDCCH/PDSCH)

### Preconditions

System Information Block Type 1 (SIB1) acquisition is performed once the MIB has been decoded.

### Success Path

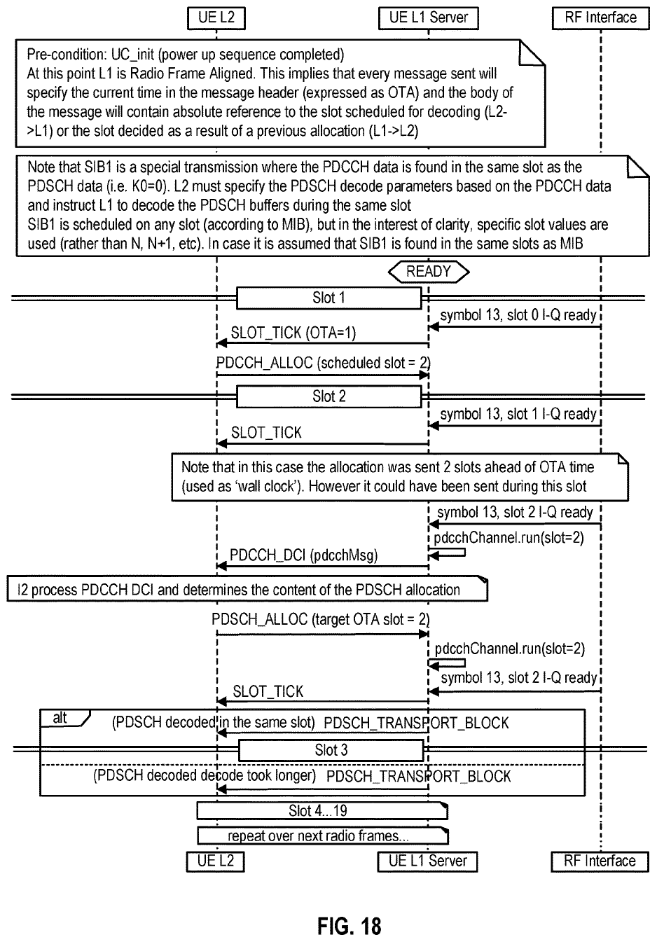

FIG. 18 shows the expected sequence in the context of a successful execution path per some embodiments.

### Random Access

This chapter describes the procedures for random access.
Contention-based random access
Contention-free random access

### Preconditions

Random access can be started when UE has acquired information form MIB and SIB1 Success Path

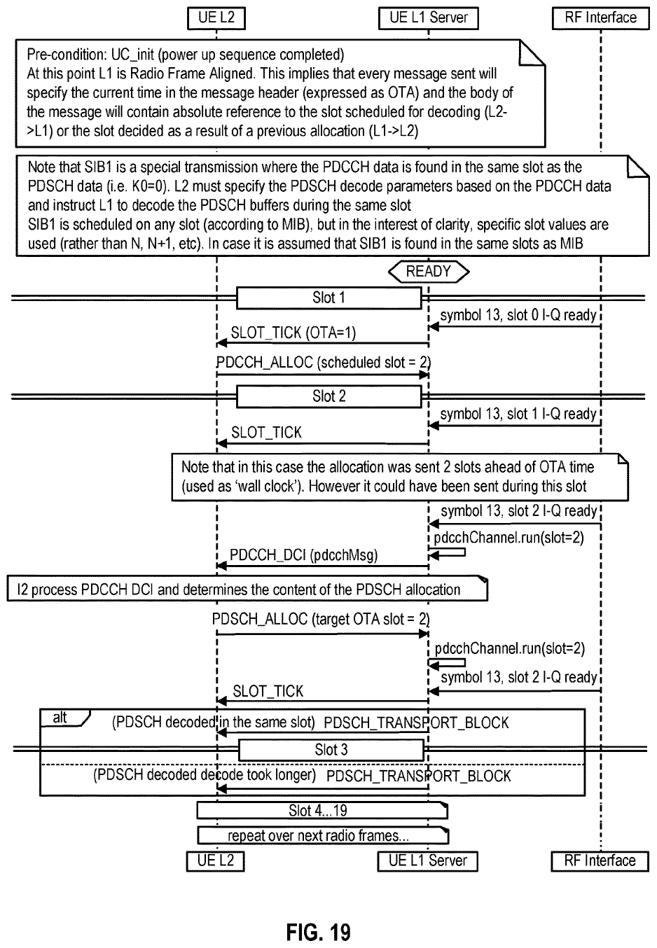

FIG. 19 depicts the expected sequence in the context of a successful execution path per some embodiments.

### Design Assumptions

UE L1 Accelerator does not perform PRACH power control, the transmission power shall be configured by UE L2 via messages
UE L1 Accelerator does not repeat PRACH attempt in case of Random access failure.

### Operations in Some Embodiments

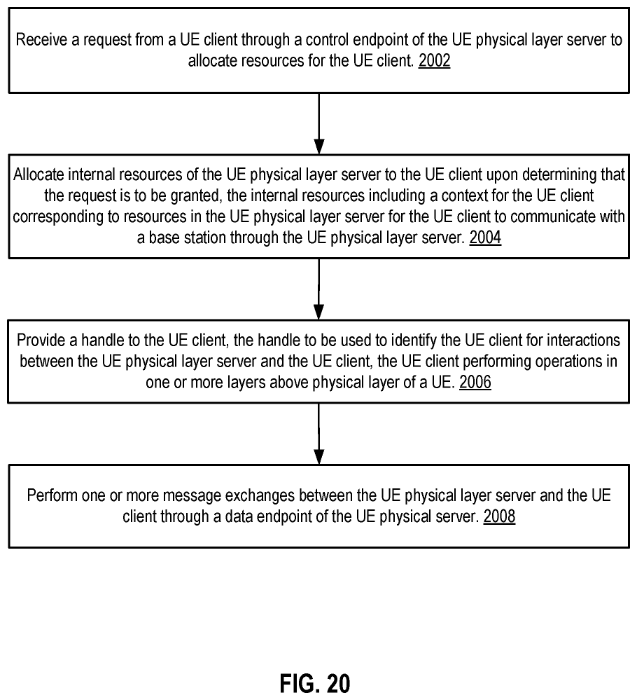

FIG. 20 shows operations at a user equipment (UE) physical layer server (e.g., the UE PHY server or L1 server) per some embodiments. The UE physical layer server may be implemented in an electronic device such as electronic device 2302 and it may be UE PHY server 234 or L1 server 752 discussed herein above.

At reference 2002, a request is received from a UE client through a control endpoint of the UE physical layer server to allocate resources for the UE client. At reference 2004, internal resources of the UE physical layer server are allocated to the UE client upon determining that the request is to be granted, the internal resources including a context for the UE client corresponding to resources in the UE physical layer server for the UE client to communicate with a base station through the UE physical layer server. At reference 2006, a handle is provided to the UE client, the handle is to be used to identify the UE client for interactions between the UE physical layer server and the UE client, the UE client performing operations in one or more layers above physical layer of a UE. At reference 2008, one or more message exchanges are performed between the UE physical layer server and the UE client through a data endpoint of the UE physical server.

In some embodiments, the request includes one or more of a number of antennas, frequency bands, bandwidth to be allocated to the UE client.

In some embodiments, the UE physical layer server is to initiate creation of one context for one UE client.

In some embodiments, the one or more layers above physical layer of a UE include media access control (MAC) layer of the UE.

In some embodiments, a message exchanged between the UE physical layer server and the UE client indicates corresponding timing of the message, wherein a timing indication corresponds to one or more of a system frame number, a subframe, a slot, and a symbol.

In some embodiments, a message exchanged between the UE physical layer server and the UE client uses a buffer, which is allocated and released based on a pre-defined time period.

In some embodiments, the control endpoint and the data endpoint of the UE physical layer server are implemented using an application programming interface (API). In some embodiments, the API defines message type and size of a message to be exchanged with the UE physical layer server. In some embodiments, a state of the UE physical layer server is configured and queried through the API. In some embodiments, based on a measurement request from the UE client, the UE physical layer server uses one or more UE antennas coupled to the base station to measure cells serving the UE client.

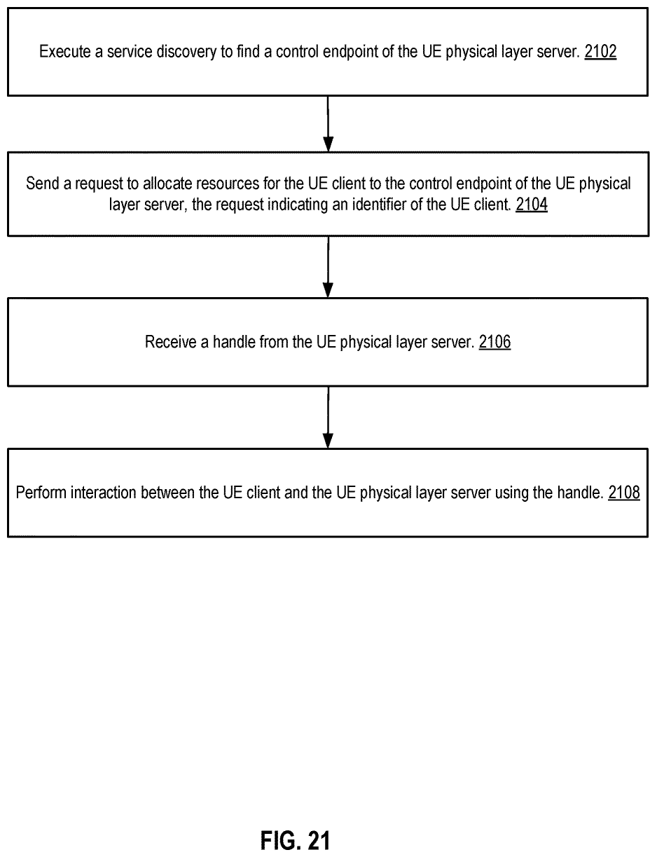

FIG. 21 shows operations at a user equipment (UE) client (e.g., a UE MAC client and/or UE L2) per some embodiments. The UE client may be implemented in an electronic device such as electronic device 2302 and it may be one or more of UE MAC clients 252, 254, and L2/L3 instance 754 to interact with a UE physical layer server as discussed herein above.

At reference 2102, a service discovery is executed to find a control endpoint of the UE physical layer server. At reference 2104, a request to allocate resources for the UE client is sent to the control endpoint of the UE physical layer server, the request indicating an identifier of the UE client. At reference 2106, a handle is received from the UE physical layer server, and at reference 2108, interaction is performed between the UE client and the UE physical layer server using the handle.

In some embodiments, the request includes one or more of a number of antennas, frequency bands, bandwidth to be allocated to the UE client.

In some embodiments, the control endpoint and the data endpoint of the UE physical layer server are implemented using an application programming interface (API).

In some embodiments, wherein the handle is created based on the identifier of the UE client.

In some embodiments, the interaction between the UE client and the physical layer is based on a synchronized system clock between the UE client and the physical layer, and wherein the synchronized system clock is indicated through one or more of a system frame number, a subframe, a slot, and a symbol.

### Radio Resources Used in a Wireless Network

FIG. 22A shows an exemplary signal transmission hierarchy in a wireless network. The exemplary signal transmission hierarchy includes the transmission unit of frame such as radio frame 2202. A radio frame 2202 takes ten milliseconds to transmit in one embodiment. The frame may contain a number of subframes such as subframe 2204. In this example, the radio frame 2202 contains ten subframes, each takes one millisecond. Each subframe may contain a number of slots. For example, a subframe may contain two slots. Each slot such as the slot at reference 2206 may contain a number of symbols. In one example, a slot contains either 7 or 14 symbols. The symbol is an orthogonal frequency-division multiplexing (OFDM) symbol in one embodiment.

The frame—subframe—slot—symbol hierarchy is an example of time domain hierarchy. In the frequency domain (as illustrated at reference 2232), each symbol may be transmitted over a number of subcarriers. A symbol may be transmitted using a number of resource blocks (RBs), each of which may contain 12 subcarriers in one embodiment. In one embodiment, each subcarrier includes a bandwidth (e.g., 7.5 kHz or 15 kHz) for transmission. One subcarrier X one symbol may be referred to as a resource element (RE), which is the smallest unit of resource to be allocated for signal transmission in one embodiment.

The illustrated frame structure offers an example for signal transmission. In this frame structure or other frame structures, data and signaling transmission is performed at a lowest level of time unit (symbol level in this case), which is included in a time unit (slot level in this example) a level over the lowest level of time unit in one embodiment. Data and signaling for one transmission from a source network device to a destination network device often use the same position within the signal transmission hierarchy, e.g., the same symbol position in consecutive slots (e.g., symbol #2 of each slot) or subframes, or in alternating slots (e.g., symbol #2 in every other slot) or subframes.

FIG. 22B shows resource elements used for data and signaling transmission. The physical resources for transmission may be viewed as time and frequency grids as illustrated, where each resource element occupies a time period in the time domain and a frequency range in the frequency domain. Each OFDM symbol includes a cyclic prefix as illustrated at reference 2252. Each OFDM symbol utilizes a number of resource elements. In this example, the sub-carrier spacing is 15 k Hz, and the resource element (RE) 2252 occupies orthogonal frequency-division multiplexing (OFDM) subcarriers within an OFDM symbol. A network device may allocate some resource elements for a particular type of signaling. Such allocation may be specified through identifying the time period in the time domain and the frequency range in the frequency domain in a signal transmission hierarchy; or it may be specified through identifying specific resource elements within the signal transmission hierarchy.

For downlink control, a wireless network may use PDCCHs (physical downlink control channels) to transmit downlink control information (DCI), which provides downlink scheduling assignments and uplink scheduling grants. The PDCCHs are transmitted at the beginning of a slot and relate to data in the same or a later slot (for mini-slots PDCCH can also be transmitted within a regular slot) in some embodiments. Different formats (sizes) of the PDCCHs are possible to handle different DCI payload sizes and different aggregation levels (i.e., different code rate for a given payload size). A UE may be configured (implicitly and/or explicitly) to blindly monitor (or search) for a number of PDCCH candidates of different aggregation levels and DCI payload sizes. Upon detecting a valid DCI message (e.g., the decoding of a candidate being successful, and the DCI contains an ID that the UE is told to monitor) the UE follows the DCI (e.g., receives the corresponding downlink data or transmits in the uplink). The blind decoding process comes at a cost in complexity in the UE but is required to provide flexible scheduling and handling of different DCI payload sizes.

Different NR use-cases (e.g., MBB (mobile broadband), URLLC (ultra-reliable low latency communication)) require different control regions (e.g., time, frequency, numerologies etc.) & PDCCH configurations (e.g., operating points etc.) PDCCHs in NR are transmitted in configurable/dynamic control regions called control resource sets (CORESET) enabling variable use-cases. A CORESET is a subset of the downlink physical resource configured to carry control signaling. It is analogous to the control region in LTE but generalized in the sense that the set of physical resource blocks (PRBs) and the set of OFDM symbols in which it is located is configurable.

In one embodiment, CORESET configuration in frequency allocation is done in units of 6 RBs using NR DL resource allocation Type 0: bitmap of RB groups (RBGs). CORESET configuration in time spans of 1-3 consecutive OFDM symbols. For slot-based scheduling, the CORESET span at the beginning of a slot is at most 2 if demodulation reference signal (DMRS) is located in OFDM Symbol (OS) #2 and is at most 3 if DMRS is located in OS #3. A UE monitors one or more CORESETs. Multiple CORESETs can be overlapped in frequency and time for a UE.

### Cloud Implementation

This invention is directly related to cloud usage, when describing L1 and L2 processes/units/entities it should be understood that these can be deployed using different cloud technologies, e.g., via VMs, containers or pods in Kubernetes.

### O-RAN Implementation

The described invention directly supports the goals of O-RAN (disaggregation, components possibly supplied by different vendors) but focuses on the UE instead of the network side.

### Technical Specification Impact

The realization of this invention requires the implementation of various 3GPP procedures in some embodiments. To our understanding, 3GPP does not directly cover soft UE implementation, nor dedicated aspects for multiple simulated UEs.

### Devices and Systems Implementing Some Embodiments

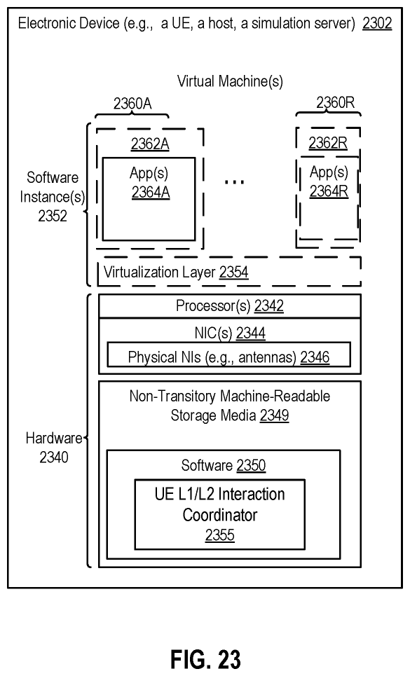

FIG. 23 illustrates an electronic device implementing UE L1/L2 interaction coordinator per some embodiments. The electronic device may be a host in a cloud system, or a network node/UE in a wireless/wireline network, and the operating environment. Further embodiments the host, the network node, the UE are discussed in more details herein below.

The electronic device 2302 may be implemented using custom application-specific integrated-circuits (ASICs) as processors and a special-purpose operating system (OS), or common off-the-shelf (COTS) processors and a standard OS. In some embodiments, the electronic device 2302 implements a UE L1/L2 interaction coordinator 2355 that performs the operations discussed herein above relating to FIGS. 1 to 19. The electronic device may include the UE physical layer server, one or more UE clients (e.g., UE MAC clients), or the combination of the two.

The electronic device 2302 includes hardware 2340 comprising a set of one or more processors 2342 (which are typically COTS processors or processor cores or ASICs) and physical NIs 2346, as well as non-transitory machine-readable storage media 2349 having stored therein software 2350. During operation, the one or more processors 2342 may execute the software 2350 to instantiate one or more sets of one or more applications 2364A-R. While one embodiment does not implement virtualization, alternative embodiments may use different forms of virtualization. For example, in one such alternative embodiment, the virtualization layer 2354 represents the kernel of an operating system (or a shim executing on a base operating system) that allows for the creation of multiple instances 2362A-R called software containers that may each be used to execute one (or more) of the sets of applications 2364A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 2354 represents a hypervisor (sometimes referred to as a virtual machine monitor (VMM)) or a hypervisor executing on top of a host operating system, and each of the sets of applications 2364A-R run on top of a guest operating system within an instance 2362A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 2340, directly on a hypervisor (in which case the unikernel is sometimes described as running within a LibOS virtual machine), or in a software container, embodiments can be implemented fully with unikernels running directly on a hypervisor represented by virtualization layer 2354, unikernels running within software containers represented by instances 2362A-R, or as a combination of unikernels and the above-described techniques (e.g., unikernels and virtual machines both run directly on a hypervisor, unikernels, and sets of applications that are run in different software containers).

The UE L1/L2 interaction coordinator 2355 may be instantiated within the applications 2364A-R. The instantiation of the one or more sets of one or more applications 2364A-R, as well as virtualization if implemented, are collectively referred to as software instance(s) 2352. Each set of applications 2364A-R, corresponding virtualization construct (e.g., instance 2362A-R) if implemented, and that part of the hardware 2340 that executes them (be it hardware dedicated to that execution and/or time slices of hardware temporally shared), forms a separate virtual electronic device 2360A-R.

A network interface (NI) may be physical or virtual. In the context of Internet Protocol (IP), an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 2344. The physical network interface 2346 may include one or more antenna of the electronic device 2302. An antenna port may or may not correspond to a physical antenna. The antenna comprises one or more radio interfaces.

### A Wireless Network Per Some Embodiments

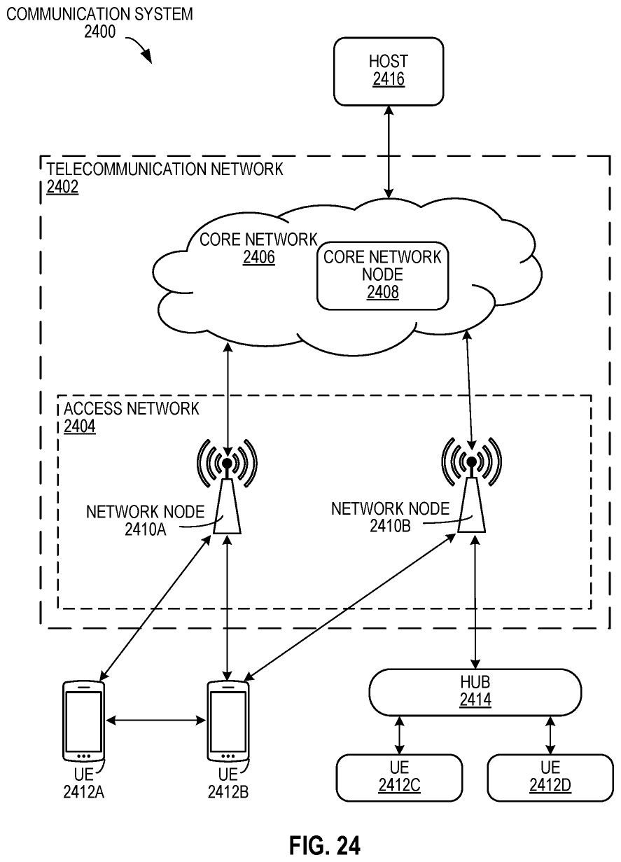

FIG. 24 illustrates an example of a communication system per some embodiments. In the example, the communication system 2400 includes a telecommunication network 2402 that includes an access network 2404, such as a radio access network (RAN), and a core network 2406, which includes one or more core network nodes 2408. The access network 2404 includes one or more access network nodes, such as network nodes 2410a and 2410b (one or more of which may be generally referred to as network nodes 2410), or any other similar 3rd Generation Partnership Project (3GPP) access node or non-3GPP access point. The network nodes 2410 facilitate direct or indirect connection of user equipment (UE), such as by connecting UEs 2412a, 2412b, 2412c, and 2412d (one or more of which may be generally referred to as UEs 2412) to the core network 2406 over one or more wireless connections. Each of the UEs 2412a to 2412d may be implemented using the novel MAC-PHY interface discussed herein above.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2400 may include any number of wired or wireless networks, network nodes, UEs, and/or any other components or systems that may facilitate or participate in the communication of data and/or signals whether via wired or wireless connections. The communication system 2400 may include and/or interface with any type of communication, telecommunication, data, cellular, radio network, and/or other similar type of system.

The UEs 2412 may be any of a wide variety of communication devices, including wireless devices arranged, configured, and/or operable to communicate wirelessly with the network nodes 2410 and other communication devices. Similarly, the network nodes 2410 are arranged, capable, configured, and/or operable to communicate directly or indirectly with the UEs 2412 and/or with other network nodes or equipment in the telecommunication network 2402 to enable and/or provide network access, such as wireless network access, and/or to perform other functions, such as administration in the telecommunication network 2402.

In the depicted example, the core network 2406 connects the network nodes 2410 to one or more hosts, such as host 2416. These connections may be direct or indirect via one or more intermediary networks or devices. In other examples, network nodes may be directly coupled to hosts. The core network 2406 includes one more core network nodes (e.g., core network node 2408) that are structured with hardware and software components. Features of these components may be substantially similar to those described with respect to the UEs, network nodes, and/or hosts, such that the descriptions thereof are generally applicable to the corresponding components of the core network node 2408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2416 may be under the ownership or control of a service provider other than an operator or provider of the access network 2404 and/or the telecommunication network 2402, and may be operated by the service provider or on behalf of the service provider. The host 2416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2400 of FIG. 24 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2402 is a cellular network that implements 3GPP standardized features. Accordingly, the telecommunication network 2402 may support network slicing to provide different logical networks to different devices that are connected to the telecommunication network 2402. For example, the telecommunication network 2402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2412 are configured to transmit and/or receive information without direct human interaction. For instance, a UE may be designed to transmit information to the access network 2404 on a predetermined schedule, when triggered by an internal or external event, or in response to requests from the access network 2404. Additionally, a UE may be configured for operating in single- or multiple radio access technology (multi-RAT) or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 2414 communicates with the access network 2404 to facilitate indirect communication between one or more UEs (e.g., UE 2412c and/or 2412d) and network nodes (e.g., network node 2410b). In some examples, the hub 2414 may be a controller, router, content source and analytics, or any of the other communication devices described herein regarding UEs. For example, the hub 2414 may be a broadband router enabling access to the core network 2406 for the UEs. As another example, the hub 2414 may be a controller that sends commands or instructions to one or more actuators in the UEs. Commands or instructions may be received from the UEs, network nodes 2410, or by executable code, script, process, or other instructions in the hub 2414. As another example, the hub 2414 may be a data collector that acts as temporary storage for UE data and, in some embodiments, may perform analysis or other processing of the data. As another example, the hub 2414 may be a content source. For example, for a UE that is a virtual reality (VR) headset, display, loudspeaker or other media delivery device, the hub 2414 may retrieve VR assets, video, audio, or other media or data related to sensory information via a network node, which the hub 2414 then provides to the UE either directly, after performing local processing, and/or after adding additional local content. In still another example, the hub 2414 acts as a proxy server or orchestrator for the UEs, in particular in if one or more of the UEs are low energy IoT devices.

The hub 2414 may have a constant/persistent or intermittent connection to the network node 2410b. The hub 2414 may also allow for a different communication scheme and/or schedule between the hub 2414 and UEs (e.g., UE 2412c and/or 2412d), and between the hub 2414 and the core network 2406. In other examples, the hub 2414 is connected to the core network 2406 and/or one or more UEs via a wired connection. Moreover, the hub 2414 may be configured to connect to a machine-to-machine (M2M) service provider over the access network 2404 and/or to another UE over a direct connection. In some scenarios, UEs may establish a wireless connection with the network nodes 2410 while still connected via the hub 2414 via a wired or wireless connection. In some embodiments, the hub 2414 may be a dedicated hub—that is, a hub whose primary function is to route communications to/from the UEs from/to the network node 2410b. In other embodiments, the hub 2414 may be a non-dedicated hub—that is, a device which is capable of operating to route communications between the UEs and network node 2410b, but which is additionally capable of operating as a communication start and/or end point for certain data channels.

### UE Per Some Embodiments

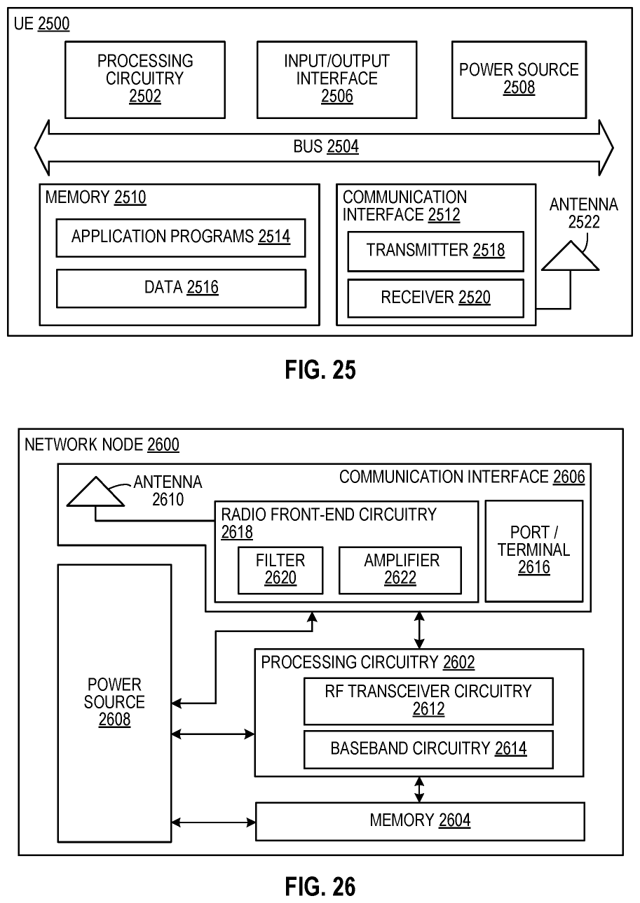

FIG. 25 illustrates a User Equipment (UE) per some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE. UE2500 may be implemented with the UE physical layer server and the UE MAC client discussed herein above.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 2500 includes processing circuitry 2502 that is operatively coupled via a bus 2504 to an input/output interface 2506, a power source 2508, a memory 2510, a communication interface 2512, and/or any other component, or any combination thereof. Certain UEs may utilize all or a subset of the components shown in FIG. 25. The level of integration between the components may vary from one UE to another UE. Further, certain UEs may contain multiple instances of a component, such as multiple processors, memories, transceivers, transmitters, receivers, etc.

The processing circuitry 2502 is configured to process instructions and data and may be configured to implement any sequential state machine operative to execute instructions stored as machine-readable computer programs in the memory 2510. The processing circuitry 2502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2502 may include multiple central processing units (CPUs).

In the example, the input/output interface 2506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2508 is structured as a battery or battery pack. Other types of power sources, such as an external power source (e.g., an electricity outlet), photovoltaic device, or power cell, may be used. The power source 2508 may further include power circuitry for delivering power from the power source 2508 itself, and/or an external power source, to the various parts of the UE 2500 via input circuitry or an interface such as an electrical power cable. Delivering power may be, for example, for charging of the power source 2508. Power circuitry may perform any formatting, converting, or other modification to the power from the power source 2508 to make the power suitable for the respective components of the UE 2500 to which power is supplied.

The memory 2510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2510 includes one or more application programs 2514, such as an operating system, web browser application, a widget, gadget engine, or other application, and corresponding data 2516. The memory 2510 may store, for use by the UE 2500, any of a variety of various operating systems or combinations of operating systems.

The memory 2510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or IP Multimedia Services Identity Module (ISIM), other memory, or any combination thereof. The UICC may for example be an embedded UICC (eUICC), integrated UICC (iUICC) or a removable UICC commonly known as ‘SIM card.’ The memory 2510 may allow the UE 2500 to access instructions, application programs and the like, stored on transitory or non-transitory memory media, to off-load data, or to upload data. An article of manufacture, such as one utilizing a communication system may be tangibly embodied as or in the memory 2510, which may be or comprise a device-readable storage medium.

The processing circuitry 2502 may be configured to communicate with an access network or other network using the communication interface 2512. The communication interface 2512 may comprise one or more communication subsystems and may include or be communicatively coupled to an antenna 2522. The communication interface 2512 may include one or more transceivers used to communicate, such as by communicating with one or more remote transceivers of another device capable of wireless communication (e.g., another UE or a network node in an access network). Each transceiver may include a transmitter 2518 and/or a receiver 2520 appropriate to provide network communications (e.g., optical, electrical, frequency allocations, and so forth). Moreover, the transmitter 2518 and receiver 2520 may be coupled to one or more antennas (e.g., antenna 2522) and may share circuit components, software or firmware, or alternatively be implemented separately.

In the illustrated embodiment, communication functions of the communication interface 2512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), Quick UDP Internet Connections (QUIC), Hypertext Transfer Protocol (HTTP), and so forth.

Regardless of the type of sensor, a UE may provide an output of data captured by its sensors, through its communication interface 2512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2500 shown in FIG. 25.

As yet another specific example, in an IoT scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 26 illustrates a network node per some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2600 includes a processing circuitry 2602, a memory 2604, a communication interface 2606, and a power source 2608. The network node 2600 may be composed of multiple physically separate components (e.g., a NodeB component and a RNC component, or a BTS component and a BSC component, etc.), which may each have their own respective components. In certain scenarios in which the network node 2600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2600 may be configured to support multiple radio access technologies (RATs). In such embodiments, some components may be duplicated (e.g., separate memory 2604 for different RATs) and some components may be reused (e.g., a same antenna 2610 may be shared by different RATs). The network node 2600 may also include multiple sets of the various illustrated components for different wireless technologies integrated into network node 2600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2600.

The processing circuitry 2602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2600 components, such as the memory 2604, to provide network node 2600 functionality.

In some embodiments, the processing circuitry 2602 includes a system on a chip (SOC). In some embodiments, the processing circuitry 2602 includes one or more of radio frequency (RF) transceiver circuitry 2612 and baseband processing circuitry 2614. In some embodiments, the radio frequency (RF) transceiver circuitry 2612 and the baseband processing circuitry 2614 may be on separate chips (or sets of chips), boards, or units, such as radio units and digital units. In alternative embodiments, part or all of RF transceiver circuitry 2612 and baseband processing circuitry 2614 may be on the same chip or set of chips, boards, or units.

The memory 2604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2602. The memory 2604 may store any suitable instructions, data, or information, including a computer program, software, an application including one or more of logic, rules, code, tables, and/or other instructions capable of being executed by the processing circuitry 2602 and utilized by the network node 2600. The memory 2604 may be used to store any calculations made by the processing circuitry 2602 and/or any data received via the communication interface 2606. In some embodiments, the processing circuitry 2602 and memory 2604 is integrated.

The communication interface 2606 is used in wired or wireless communication of signaling and/or data between a network node, access network, and/or UE. As illustrated, the communication interface 2606 comprises port(s)/terminal(s) 2616 to send and receive data, for example to and from a network over a wired connection. The communication interface 2606 also includes radio front-end circuitry 2618 that may be coupled to, or in certain embodiments a part of, the antenna 2610. Radio front-end circuitry 2618 comprises filters 2620 and amplifiers 2622. The radio front-end circuitry 2618 may be connected to an antenna 2610 and processing circuitry 2602. The radio front-end circuitry may be configured to condition signals communicated between antenna 2610 and processing circuitry 2602. The radio front-end circuitry 2618 may receive digital data that is to be sent out to other network nodes or UEs via a wireless connection. The radio front-end circuitry 2618 may convert the digital data into a radio signal having the appropriate channel and bandwidth parameters using a combination of filters 2620 and/or amplifiers 2622. The radio signal may then be transmitted via the antenna 2610. Similarly, when receiving data, the antenna 2610 may collect radio signals which are then converted into digital data by the radio front-end circuitry 2618. The digital data may be passed to the processing circuitry 2602. In other embodiments, the communication interface may comprise different components and/or different combinations of components.

In certain alternative embodiments, the network node 2600 does not include separate radio front-end circuitry 2618, instead, the processing circuitry 2602 includes radio front-end circuitry and is connected to the antenna 2610. Similarly, in some embodiments, all or some of the RF transceiver circuitry 2612 is part of the communication interface 2606. In still other embodiments, the communication interface 2606 includes one or more ports or terminals 2616, the radio front-end circuitry 2618, and the RF transceiver circuitry 2612, as part of a radio unit (not shown), and the communication interface 2606 communicates with the baseband processing circuitry 2614, which is part of a digital unit (not shown).

The antenna 2610 may include one or more antennas, or antenna arrays, configured to send and/or receive wireless signals. The antenna 2610 may be coupled to the radio front-end circuitry 2618 and may be any type of antenna capable of transmitting and receiving data and/or signals wirelessly. In certain embodiments, the antenna 2610 is separate from the network node 2600 and connectable to the network node 2600 through an interface or port.

The antenna 2610, communication interface 2606, and/or the processing circuitry 2602 may be configured to perform any receiving operations and/or certain obtaining operations described herein as being performed by the network node. Any information, data and/or signals may be received from a UE, another network node and/or any other network equipment. Similarly, the antenna 2610, the communication interface 2606, and/or the processing circuitry 2602 may be configured to perform any transmitting operations described herein as being performed by the network node. Any information, data and/or signals may be transmitted to a UE, another network node and/or any other network equipment.

The power source 2608 provides power to the various components of network node 2600 in a form suitable for the respective components (e.g., at a voltage and current level needed for each respective component). The power source 2608 may further comprise, or be coupled to, power management circuitry to supply the components of the network node 2600 with power for performing the functionality described herein. For example, the network node 2600 may be connectable to an external power source (e.g., the power grid, an electricity outlet) via an input circuitry or interface such as an electrical cable, whereby the external power source supplies power to power circuitry of the power source 2608. As a further example, the power source 2608 may comprise a source of power in the form of a battery or battery pack which is connected to, or integrated in, power circuitry. The battery may provide backup power should the external power source fail.

Embodiments of the network node 2600 may include additional components beyond those shown in FIG. 26 for providing certain aspects of the network node's functionality, including any of the functionality described herein and/or any functionality necessary to support the subject matter described herein. For example, the network node 2600 may include user interface equipment to allow input of information into the network node 2600 and to allow output of information from the network node 2600. This may allow a user to perform diagnostic, maintenance, repair, and other administrative functions for the network node 2600.

### Host Per Some Embodiments

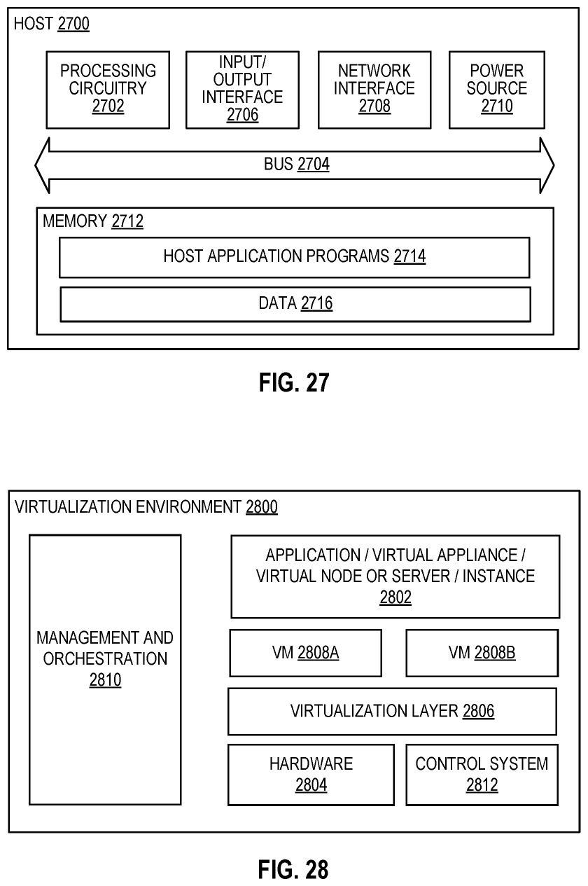

FIG. 27 is a block diagram of a host, which may be an embodiment of the host of FIG. 24, per various aspects described herein. As used herein, the host 2700 may be or comprise various combinations hardware and/or software, including a standalone server, a blade server, a cloud-implemented server, a distributed server, a virtual machine, container, or processing resources in a server farm. The host 2700 may provide one or more services to one or more UEs. In some embodiment, host 2700 may implement the UE physical layer server and/or the UE MAC client discussed herein above.

The host 2700 includes processing circuitry 2702 that is operatively coupled via a bus 2704 to an input/output interface 2706, a network interface 2708, a power source 2710, and a memory 2712. Other components may be included in other embodiments. Features of these components may be substantially similar to those described with respect to the devices of previous figures, such as FIGS. 25 and 26, such that the descriptions thereof are generally applicable to the corresponding components of host 2700.

The memory 2712 may include one or more computer programs including one or more host application programs 2714 and data 2716, which may include user data, e.g., data generated by a UE for the host 2700 or data generated by the host 2700 for a UE. Embodiments of the host 2700 may utilize only a subset or all of the components shown. The host application programs 2714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, heads-up display systems). The host application programs 2714 may also provide for user authentication and licensing checks and may periodically report health, routes, and content availability to a central node, such as a device in or on the edge of a core network. Accordingly, the host 2700 may select and/or indicate a different host for over-the-top services for a UE. The host application programs 2714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 28 is a block diagram illustrating a virtualization environment in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2802 (which may alternatively be called software instances, virtual appliances, network functions, virtual nodes, virtual network functions, etc.) are run in the virtualization environment 2800 to implement some of the features, functions, and/or benefits of some of the embodiments disclosed herein.

Hardware 2804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2806 (also referred to as hypervisors or virtual machine monitors (VMMs)), provide VMs 2808a and 2808b (one or more of which may be generally referred to as VMs 2808), and/or perform any of the functions, features and/or benefits described in relation with some embodiments described herein. The virtualization layer 2806 may present a virtual operating platform that appears like networking hardware to the VMs 2808.

The VMs 2808 comprise virtual processing, virtual memory, virtual networking or interface and virtual storage, and may be run by a corresponding virtualization layer 2806. Different embodiments of the instance of a virtual appliance 2802 may be implemented on one or more of VMs 2808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2808 may be a software implementation of a physical machine that runs programs as if they were executing on a physical, non-virtualized machine. Each of the VMs 2808, and that part of hardware 2804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2808 on top of the hardware 2804 and corresponds to the application 2802.

Hardware 2804 may be implemented in a standalone network node with generic or specific components. Hardware 2804 may implement some functions via virtualization. Alternatively, hardware 2804 may be part of a larger cluster of hardware (e.g., such as in a data center or CPE) where many hardware nodes work together and are managed via management and orchestration 2810, which, among others, oversees lifecycle management of applications 2802. In some embodiments, hardware 2804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2812 which may alternatively be used for communication between hardware nodes and radio units.

### Communication Among Host, Network Node, and UE Per Some Embodiments

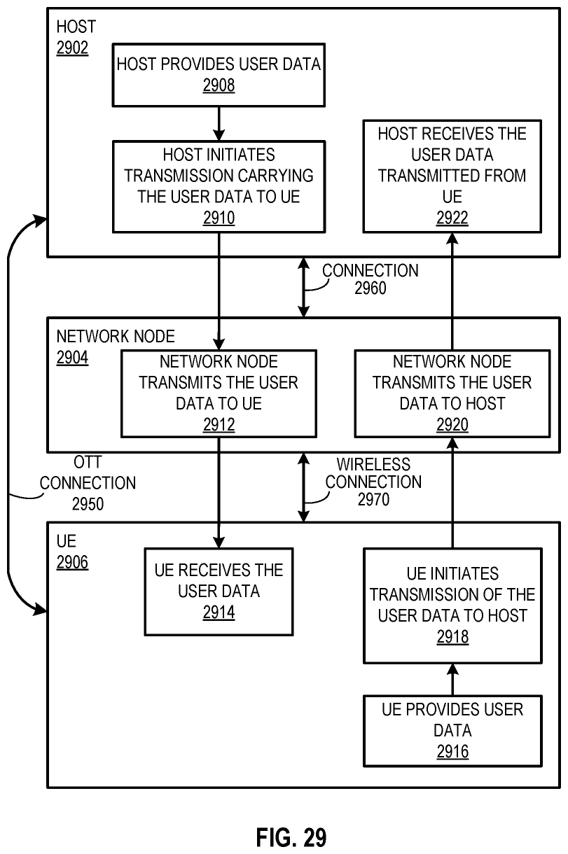

FIG. 29 illustrates a communication diagram of a host communicating via a network node with a UE over a partially wireless connection per some embodiments. Example implementations, in accordance with various embodiments, of the UE (such as a UE 2412a of FIG. 24 and/or UE 2500 of FIG. 25), network node (such as network node 2410a of FIG. 24 and/or network node 2600 of FIG. 26), and host (such as host 2416 of FIG. 24 and/or host 2700 of FIG. 27) discussed in the preceding paragraphs will now be described with reference to FIG. 29.

Like host 2700, embodiments of host 2902 include hardware, such as a communication interface, processing circuitry, and memory. The host 2902 also includes software, which is stored in or accessible by the host 2902 and executable by the processing circuitry. The software includes a host application that may be operable to provide a service to a remote user, such as the UE 2906 connecting via an over-the-top (OTT) connection 2950 extending between the UE 2906 and host 2902. In providing the service to the remote user, a host application may provide user data which is transmitted using the OTT connection 2950.

The network node 2904 includes hardware enabling it to communicate with the host 2902 and UE 2906. The connection 2960 may be direct or pass through a core network (like core network 2406 of FIG. 24) and/or one or more other intermediate networks, such as one or more public, private, or hosted networks. For example, an intermediate network may be a backbone network or the Internet.

The UE 2906 includes hardware and software, which is stored in or accessible by UE 2906 and executable by the UE's processing circuitry. The software includes a client application, such as a web browser or operator-specific “app” that may be operable to provide a service to a human or non-human user via UE 2906 with the support of the host 2902. In the host 2902, an executing host application may communicate with the executing client application via the OTT connection 2950 terminating at the UE 2906 and host 2902. In providing the service to the user, the UE's client application may receive request data from the host's host application and provide user data in response to the request data. The OTT connection 2950 may transfer both the request data and the user data. The UE's client application may interact with the user to generate the user data that it provides to the host application through the OTT connection 2950.

The OTT connection 2950 may extend via a connection 2960 between the host 2902 and the network node 2904 and via a wireless connection 2970 between the network node 2904 and the UE 2906 to provide the connection between the host 2902 and the UE 2906. The connection 2960 and wireless connection 2970, over which the OTT connection 2950 may be provided, have been drawn abstractly to illustrate the communication between the host 2902 and the UE 2906 via the network node 2904, without explicit reference to any intermediary devices and the precise routing of messages via these devices.

As an example of transmitting data via the OTT connection 2950, in step 2908, the host 2902 provides user data, which may be performed by executing a host application. In some embodiments, the user data is associated with a particular human user interacting with the UE 2906. In other embodiments, the user data is associated with a UE 2906 that shares data with the host 2902 without explicit human interaction. In step 2910, the host 2902 initiates a transmission carrying the user data towards the UE 2906. The host 2902 may initiate the transmission responsive to a request transmitted by the UE 2906. The request may be caused by human interaction with the UE 2906 or by operation of the client application executing on the UE 2906. The transmission may pass via the network node 2904, in accordance with the teachings of the embodiments described throughout this disclosure. Accordingly, in step 2912, the network node 2904 transmits to the UE 2906 the user data that was carried in the transmission that the host 2902 initiated, in accordance with the teachings of the embodiments described throughout this disclosure. In step 2914, the UE 2906 receives the user data carried in the transmission, which may be performed by a client application executed on the UE 2906 associated with the host application executed by the host 2902.

In some examples, the UE 2906 executes a client application which provides user data to the host 2902. The user data may be provided in reaction or response to the data received from the host 2902. Accordingly, in step 2916, the UE 2906 may provide user data, which may be performed by executing the client application. In providing the user data, the client application may further consider user input received from the user via an input/output interface of the UE 2906. Regardless of the specific manner in which the user data was provided, the UE 2906 initiates, in step 2918, transmission of the user data towards the host 2902 via the network node 2904. In step 2920, in accordance with the teachings of the embodiments described throughout this disclosure, the network node 2904 receives user data from the UE 2906 and initiates transmission of the received user data towards the host 2902. In step 2922, the host 2902 receives the user data carried in the transmission initiated by the UE 2906.

In an example scenario, factory status information may be collected and analyzed by the host 2902. As another example, the host 2902 may process audio and video data which may have been retrieved from a UE for use in creating maps. As another example, the host 2902 may collect and analyze real-time data to assist in controlling vehicle congestion (e.g., controlling traffic lights). As another example, the host 2902 may store surveillance video uploaded by a UE. As another example, the host 2902 may store or control access to media content such as video, audio, VR or AR which it can broadcast, multicast or unicast to UEs. As other examples, the host 2902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2950 between the host 2902 and UE 2906, in response to variations in the measurement results. The measurement procedure and/or the network functionality for reconfiguring the OTT connection may be implemented in software and hardware of the host 2902 and/or UE 2906. In some embodiments, sensors (not shown) may be deployed in or in association with other devices through which the OTT connection 2950 passes; the sensors may participate in the measurement procedure by supplying values of the monitored quantities exemplified above, or supplying values of other physical quantities from which software may compute or estimate the monitored quantities. The reconfiguring of the OTT connection 2950 may include message format, retransmission settings, preferred routing etc.; the reconfiguring need not directly alter the operation of the network node 2904. Such procedures and functionalities may be known and practiced in the art. In certain embodiments, measurements may involve proprietary UE signaling that facilitates measurements of throughput, propagation times, latency and the like, by the host 2902. The measurements may be implemented in that software causes messages to be transmitted, in particular empty or ‘dummy’ messages, using the OTT connection 2950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Terms

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein can refer to any whole number of items including one item.

An electronic device (such as the electronic device 2302) stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals-such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### EMBODIMENTS

### Group A Embodiments

1. A method of a user equipment (UE) physical layer server to interact with one or more UE clients, comprising:
   receiving (2002) a request from a UE client through a control endpoint of the UE physical layer server to allocate resources for the UE client;
   allocating (2004) internal resources of the UE physical layer server to the UE client upon determining that the request is to be granted, the internal resources including a context for the UE client that corresponding resources in the UE physical layer server for the UE client to communicate with a base station through the UE physical layer server;
   providing (2006) a handle to the UE client, the handle is to be used to identify the UE client for interactions between the physical layer server and the UE client, the UE client performing operations in one or more layers above physical layer of a UE; and
   performing (2008) message exchange between the UE physical layer server and the UE client through a data endpoint of the UE physical server.
2. The method of embodiment 1, wherein the request includes one or more of a number of antennas, frequency bands, bandwidth to be allocated to the UE client.
3. The method of embodiment 1, where the UE physical layer server is to initiate creation of one context for one UE client.
4. The method of embodiment 1, wherein the one or more layers above physical layer of a UE include media access control (MAC) layer of the UE.
5. The method of embodiment 1, wherein a message exchanged between the UE physical layer server and the UE client indicates corresponding timing of the message, wherein a timing indication corresponds to one or more of a system frame number, a subframe, a slot, and a symbol.
6. The method of embodiment 1, wherein a message exchanged between the UE physical layer server and the UE client uses a buffer, which is allocated and released based on a pre-defined time period.
7. The method of embodiment 1, wherein the control endpoint and the data endpoint of the UE physical layer server are implemented using an application programming interface (API).
8. The method of embodiment 7, wherein the API defines message type and size of a message to be exchanged with the UE physical layer server.
9. The method of embodiment 7, where state of the UE physical layer server is configured and queried through the API.
10. The method of embodiment 7, wherein based on a measurement request from the UE client, the UE physical layer server uses one or more UE antennas coupled to the base station to measure cells serving the UE client.

### Group B Embodiments

11. A method of a user equipment (UE) client to interact with a UE physical layer server, comprising:
   running (2102) service discovery to find a control endpoint of the UE physical layer server;
   sending (2104) a request to allocate resources for the UE client to the control endpoint of the UE physical layer server, the request indicating an identifier of the UE client;
   receiving (2106) a handle from the UE physical layer server; and
   performing (2108) interaction between the UE client and the physical layer server using the handle.
12. The method of embodiment 11, wherein the request includes one or more of a number of antennas, frequency bands, bandwidth to be allocated to the UE client.

### Group C Embodiments

13. An electronic device for a user equipment (UE) physical layer server to interact with one or more UE clients, comprising:
   processing circuitry configured to perform any of the steps of any of the Group A embodiments; and
   power supply circuitry configured to supply power to the processing circuitry.
14. An electronic device for a user equipment (UE) physical layer server to interact with one or more UE clients, comprising:
   processing circuitry configured to perform any of the steps of any of the Group B embodiments; and
   power supply circuitry configured to supply power to the processing circuitry.
15. An electronic device for a user equipment (UE) physical layer server to interact with one or more UE clients, comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the electronic device.
16. A host configured to operate in a communication system, the host comprising: processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group A or B embodiments to transmit the user data from the host to the UE.
17. The host of the previous embodiment, wherein:
   the processing circuitry of the host is configured to execute a host application that provides the user data; and
   the UE comprises processing circuitry configured to execute a client application associated with the host application to receive the transmission of user data from the host.
18. A communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
19. The communication system of the previous embodiment, further comprising:
   the network node; and/or
   the UE.

1. A method of a user equipment (UE) physical layer server to interact with one or more UE clients, comprising:
receiving a request from a UE client through a control endpoint of the UE physical layer server to allocate resources for the UE client;
allocating internal resources of the UE physical layer server to the UE client upon determining that the request is to be granted, the internal resources including a context for the UE client corresponding to resources in the UE physical layer server for the UE client to communicate with a base station through the UE physical layer server;
providing a handle to the UE client, the handle to be used to identify the UE client for interactions between the UE physical layer server and the UE client, the UE client performing operations in one or more layers above physical layer of a UE; and
performing one or more message exchanges between the UE physical layer server and the UE client through a data endpoint of the UE physical server.

2. The method of claim 1, wherein the request includes one or more of a number of antennas, frequency bands, bandwidth to be allocated to the UE client.

3. The method of claim 1, where the UE physical layer server is to initiate creation of one context for one UE client.

4. The method of claim 1, wherein the one or more layers above the physical layer of the UE include media access control (MAC) layer of the UE.

5. The method of claim 1, wherein a message exchanged between the UE physical layer server and the UE client indicates corresponding timing of the message, wherein a timing indication corresponds to one or more of a system frame number, a subframe, a slot, and a symbol.

6. The method of claim 1, wherein a message exchanged between the UE physical layer server and the UE client uses a buffer, which is allocated and released based on a pre-defined time period.

7. The method of claim 1, wherein the control endpoint and the data endpoint of the UE physical layer server are implemented using an application programming interface (API).

8. The method of claim 7, wherein the API defines message type and size of a message to be exchanged with the UE physical layer server.

9. The method of claim 7, where a state of the UE physical layer server is configured and queried through the API.

10. The method of claim 7, wherein based on a measurement request from the UE client, the UE physical layer server uses one or more UE antennas coupled to the base station to measure cells serving the UE client.

11. An electronic device to implement a user equipment (UE) physical layer server to interact with one or more UE clients, comprising:
a processor and non-transitory machine-readable storage medium that provides instructions that, when executed by the processor, cause the electronic device to perform:
receiving a request from a UE client through a control endpoint of the UE physical layer server to allocate resources for the UE client;
allocating internal resources of the UE physical layer server to the UE client upon determining that the request is to be granted, the internal resources including a context for the UE client corresponding to resources in the UE physical layer server for the UE client to communicate with a base station through the UE physical layer server;
providing a handle to the UE client, the handle to be used to identify the UE client for interactions between the UE physical layer server and the UE client, the UE client performing operations in one or more layers above physical layer of a UE; and
performing one or more message exchanges between the UE physical layer server and the UE client through a data endpoint of the UE physical server.

12. The electronic device of claim 11, wherein the request includes one or more of a number of antennas, frequency bands, bandwidth to be allocated to the UE client.

13. The electronic device of claim 11, where the UE physical layer server is to initiate creation of one context for one UE client.

14. The electronic device of claim 11, wherein the one or more layers above the physical layer of the UE include media access control (MAC) layer of the UE.

15. The electronic device of claim 11, wherein a message exchanged between the UE physical layer server and the UE client indicates corresponding timing of the message, wherein a timing indication corresponds to one or more of a system frame number, a subframe, a slot, and a symbol.

16. The electronic device of claim 11, wherein a message exchanged between the UE physical layer server and the UE client uses a buffer, which is allocated and released based on a pre-defined time period.

17. The electronic device of claim 11, wherein the control endpoint and the data endpoint of the UE physical layer server are implemented using an application programming interface (API).

18-20. (canceled)

21. A non-transitory machine-readable storage medium that provides instructions that, when executed by a processor of an electronic device, cause the electronic device to perform:
receiving a request from a User Equipment (UE) client through a control endpoint of a UE physical layer server to allocate resources for the UE client;
allocating internal resources of the UE physical layer server to the UE client upon determining that the request is to be granted, the internal resources including a context for the UE client corresponding to resources in the UE physical layer server for the UE client to communicate with a base station through the UE physical layer server;
providing a handle to the UE client, the handle to be used to identify the UE client for interactions between the UE physical layer server and the UE client, the UE client performing operations in one or more layers above physical layer of a UE; and
performing one or more message exchanges between the UE physical layer server and the UE client through a data endpoint of the UE physical server.

22. The electronic device of claim 21, wherein the request includes one or more of a number of antennas, frequency bands, bandwidth to be allocated to the UE client.

23. The electronic device of claim 21, where the UE physical layer server is to initiate creation of one context for one UE client.

24-45. (canceled)
